(19) United States
(12) Patent Application Publication
(10) Pub. No.: US 2026/0072758 A1
(43) Pub. Date: Mar. 12, 2026

(54) SYSTEMS AND METHODS FOR UTILIZING ONBOARD VEHICLE HARDWARE FOR SLAM TASKS IN A CLOUD COMPUTING ENVIRONMENT

(71) Applicant: Adeia Guides Inc., San Jose, CA (US)

(72) Inventors: Christopher Phillips, Hartwell, GA (US); Charles Dasher, Lawrenceville, GA (US)

(21) Appl. No.: 18/882,574

(22) Filed: Sep. 11, 2024

(51) Int. Cl. G06F 9/50; H04L 67/101; H04L 67/1012; H04L 67/1021

(52) U.S. Cl. CPC G06F 9/5077; G06F 9/5044; G06F 9/5072; H04L 67/101; H04L 67/1012; H04L 67/1021

(57) ABSTRACT

Aspects of the present application leverage vehicle sensor capability and historical information in conjunction with 6G network slice allocation to efficiently utilize unused SLAM processing capacity of vehicles for dynamically allocating SLAM tasks. In some embodiments, a SLAM management server determines a vehicle's sensor capability and location of the vehicle. Historical information may be utilized by the SLAM server to predict availability of the vehicle to increase confidence for the SLAM task. Implementing the SLAM management server with 6G network connectivity provides for a significant upgrade in network reliability having data speeds exceeding 1 Tbps and ultra-low latency of less than 1 microsecond.

### CROSS REFERENCE TO RELATED APPLICATIONS

This patent application is related to patent application titled “SYSTEMS AND METHODS FOR UTILIZING ONBOARD VEHICLE HARDWARE FOR COMPUTE TASKS IN A CLOUD COMPUTING ENVIRONMENT” attorney docket 003597-4044-101 filed on Sep. 11, 2024 which is herein incorporated by reference in its entirety.

### BACKGROUND

This disclosure is related to computing tasks in a cloud computing environment, and in particular to utilizing onboard vehicle hardware to compute simultaneous localization and mapping (SLAM) tasks within a cloud computing environment.

### SUMMARY

Modern vehicles include a sophisticated ensemble of hardware that has significant processing capacity including SLAM. This SLAM capacity is used primarily by the vehicle for driving related tasks which may include advanced driver-assistance systems (ADAS) that infer safety hazards and automatically prevent or mitigate the detected risk. In other applications, the vehicle's SLAM capacity may be used for autonomous driving activities. However, when the vehicle is idle or parked, the vehicle's processing capacity for SLAM is unused. There is an opportunity to utilize a vehicle's unused processing capacity for SLAM tasks for other devices that require a significant level of SLAM processing. In some embodiments, the cloud service management server may be server 1204 in FIG. 12.

In one approach, to achieve SLAM capabilities, each device is equipped with its own SLAM subsystem that is tasked with SLAM tasks. Consequently, this approach necessitates increased manufacturing of SLAM systems and increased cost of SLAM components to be equipped for every device leading to increased manufacturing and labor costs. Moreover, each of these SLAM devices is also unused when it completes its own designated SLAM tasks. Alternatively, in another approach, a single centralized server may have SLAM capabilities to perform SLAM tasks on behalf of other SLAM devices. The centralized server is accessed through a network communication medium. In this centralized approach, the server may not be able to facilitate a reliable quality of service of SLAM to the task devices requesting the SLAM tasks, given that network performance diminishes with diminishing locational proximity. Such an approach results in a significant infrastructure for manufacturing and labor costs to have every location equipped with a centralized server.

To solve these problems, systems and methods are provided herein for leveraging vehicle sensor capability and historical information in conjunction with 6G network slice allocation to efficiently utilize unused SLAM processing capacity of vehicles for dynamically allocating SLAM tasks. In some embodiments, a SLAM management server determines a vehicle's sensor capability and location of the vehicle. Historical information may be utilized by the SLAM server to predict availability of the vehicle to increase confidence for the SLAM task. Implementing the SLAM management server with 6G network connectivity provides for a significant upgrade in network reliability having data speeds exceeding one terabyte per second (Tbps) and ultra-low latency of less than one microsecond.

In some embodiments, the SLAM server may receive a request for a SLAM task (e.g., provide a robot vacuum with SLAM data) from a task device (e.g., the robot vacuum). The request may have a sensor requirement, schedule, and location. For example, the request may require minimum sensor equipment of one optical camera, one infrared camera, and an inertial measurement unit (IMU) sensor to provide slam service to a vacuum robot on August 3 between 9 PM and 11 PM and hosted within a five-mile radius of Santa Cruz, California (where the vacuum robot is schedule to perform a vacuuming task).

The SLAM server may then access, via a network operating on a 6G protocol, a SLAM subsystem of a vehicle, a vehicle location, and history of availability of the vehicle. For example, the vehicle may be equipped with three optical cameras, an infrared camera (and SLAM system capable of handling input from the three optical cameras, an infrared camera), an IMU, and the vehicle may be located in Santa Cruz, CA three miles from the robot vacuum, and is historically available for SLAM tasks from 8:30 PM-6:00 AM with a 90% confidence value (e.g., because that is when the car is typically charged). The SLAM server makes a determination, based on the accessing, whether the vehicle is available to perform the SLAM task. Continuing from the example above, it is determined that the vehicle has the required sensor capability with an optical camera and an infrared camera, the location is within the required five-mile distance, and the schedule matches the required timing with 95% confidence.

The SLAM server may then cause the SLAM subsystem of the vehicle to be configured for the SLAM task based on requirements of the task device (e.g., configuring the SLAM sub system of the vehicle with software and/or firmware normally used by the vacuum). The SLAM server may also send commands to configure the optical camera on the task device to transmit specific information to specific processing units of the SLAM subsystem of the vehicle. The SLAM server may then allocate at least one network slice on the 6G network for sensor streams from the task device (e.g., robot vacuum) to the vehicle to compute SLAM data for the task device. For example, the SLAM server may allocate a network slice for both the optical camera, infrared camera, and IMU data stream sensor streams from the robot vacuum to send data to the vehicle SLAM subsystem to compute the SLAM data. In some embodiments, the vehicle SLAM subsystem streams the computed SLAM data to the task device via the allocated network slices (e.g., either via the same network slice or a different dedicated network slice for each sensor.)

In some embodiments, the SLAM server receives a determination from the vehicle that a particular sensor stream does not meet a quality-of-service threshold. For example, the optical camera from the robot vacuum is transmitting the sensor stream using an encoding that comprises insufficient resolution. The SLAM server may cause the task device to transmit the particular sensor stream with higher quality. For example, the SLAM server may provide instructions to the robot vacuum to utilize a higher-quality encode process to ensure a higher resolution clarity as is required by the SLAM subsystem of the vehicle. In some embodiments, the SLAM server may determine whether the allocated network slice for sensor streaming exceeds a bandwidth capacity threshold. If so, the SLAM server may allocate a new network slice on the network for the sensor streams.

In some embodiments, the SLAM server may generate a user-interface (e.g., at a vehicle charging station) allowing for selection of vehicle charging options. For example, selections are presented for charging the vehicle at the fastest rate without performing the SLAM task. Another selection may be made that charges the vehicle at a moderate rate while also performing the SLAM task. In some variants, selections may be made to schedule charging and future SLAM tasks via the user interface. The SLAM server may use the user interface inputs to increase confidence in availability of the vehicle.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario where a cloud service management server receives a SLAM request to provide SLAM for a robot vacuum, in accordance with some embodiments of this disclosure.

FIG. 1B shows an illustrative scenario where a cloud service management server determines, based on the accessing, whether the SLAM subsystem of the vehicle meets the sensor requirement for the SLAM task, in accordance with some embodiments of this disclosure.

FIG. 1C shows an illustrative scenario where a cloud service management server causes the SLAM subsystem to be configured for the SLAM task, in accordance with some embodiments of this disclosure.

FIG. 2 shows an illustrative scenario of a home-based vehicle charger dashboard, in accordance with some embodiments of this disclosure.

FIG. 3 shows an illustrative scenario of a 6G Network Slice definition, in accordance with some embodiments of this disclosure.

FIG. 4A shows an illustrative scenario of a vehicle SLAM subsystem with nine cameras, in accordance with some embodiments of this disclosure.

FIG. 4B shows an illustrative scenario of another vehicle SLAM subsystem with five cameras, in accordance with some embodiments of this disclosure.

FIG. 5 shows an illustrative scenario of a task device with a camera and IMU sensor, in accordance with some embodiments of this disclosure.

FIG. 6 shows an illustrative scenario of a vehicle SLAM subsystem with multiple sensors, in accordance with some embodiments of this disclosure.

FIG. 7 shows an illustrative scenario of a robot dog SLAM subsystem, in accordance with some embodiments of this disclosure.

FIG. 8 shows an illustrative scenario of a XR device SLAM subsystem, in accordance with some embodiments of this disclosure.

FIG. 9 shows an illustrative scenario of dedicated SD-WANs for SLAM tasks, in accordance with some embodiments of this disclosure.

FIG. 10 shows an illustrative scenario of SLAM interfaces over the 6G network implementing recursive network slicing, in accordance with some embodiments of this disclosure.

FIG. 11 shows illustrative user equipment devices, in accordance with some embodiments of this disclosure.

FIG. 12 shows illustrative systems, in accordance with some embodiments of this disclosure.

FIG. 13 is a flowchart of a detailed illustrative process for determining whether a SLAM subsystem of the vehicle meets the sensor requirement for the SLAM task and that the vehicle is available to perform the SLAM task, in accordance with some embodiments of this disclosure.

FIG. 14 is a flowchart of a detailed illustrative process for scheduling a future SLAM task, in accordance with some embodiments of this disclosure.

FIG. 15 is a flowchart of a detailed illustrative process for generating for display a user-interface for a vehicle charging station, in accordance with some embodiments of this disclosure.

### DETAILED DESCRIPTION

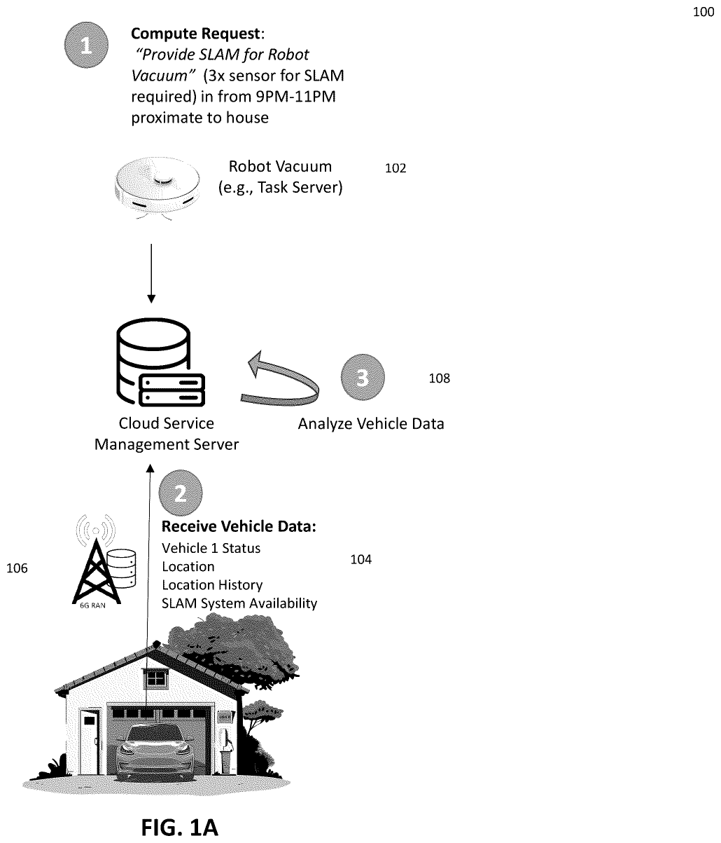

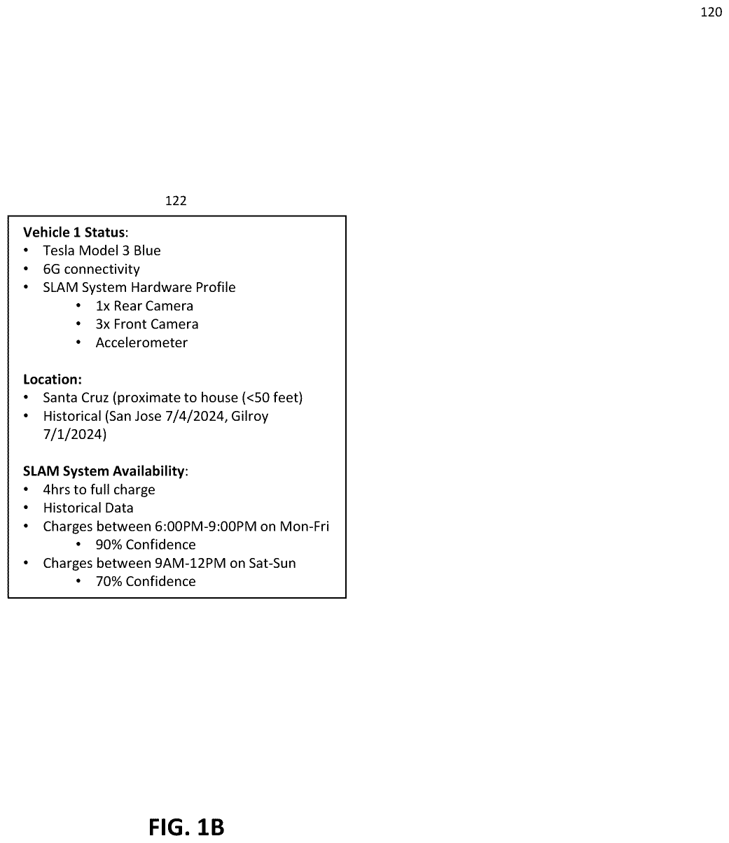

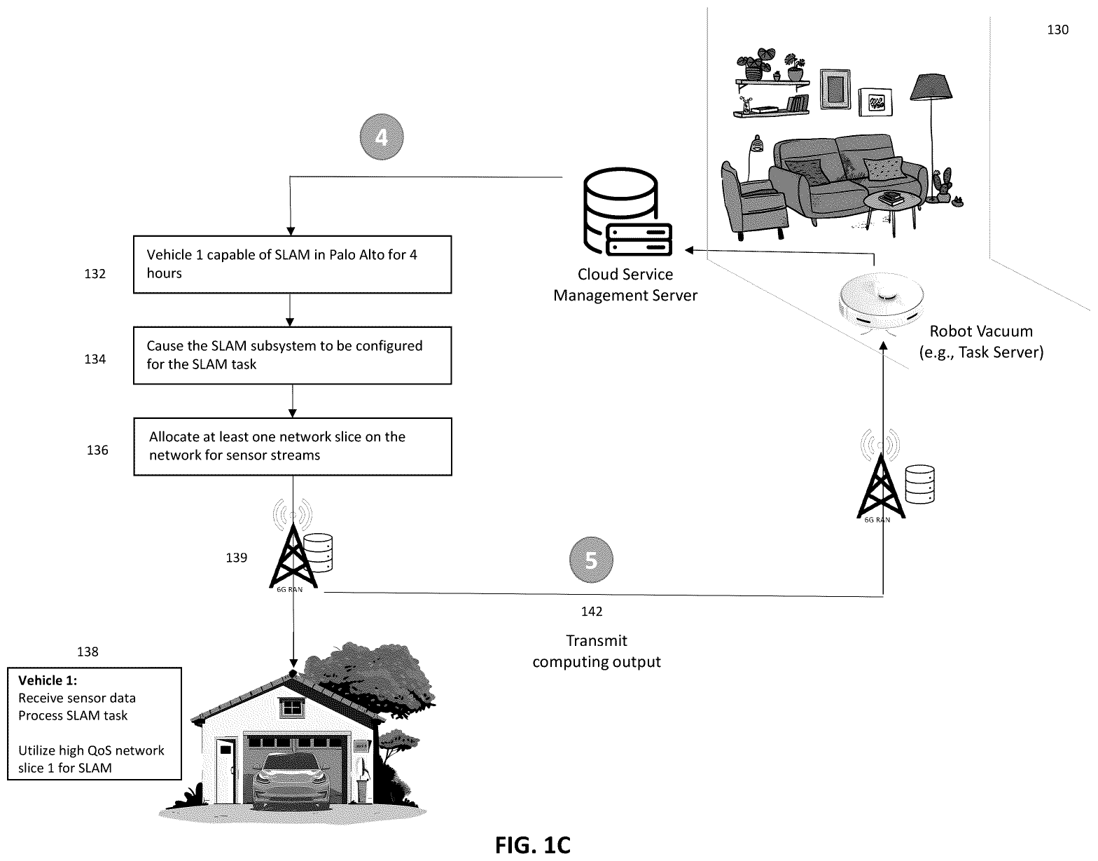

FIG. 1A shows an illustrative scenario 100 where a cloud service management server receives a SLAM request to provide SLAM for a robot vacuum, in accordance with some embodiments of this disclosure. In some embodiments, a cloud service management server is implemented to efficiently utilize unused processing capacity of vehicles for dynamically allocating SLAM tasks. In some embodiments, the cloud service management server may implement a software media application to perform the functionality of the cloud service management server. In some embodiments, the media application may run on a cloud service management server, the user equipment, or a combination of the two.

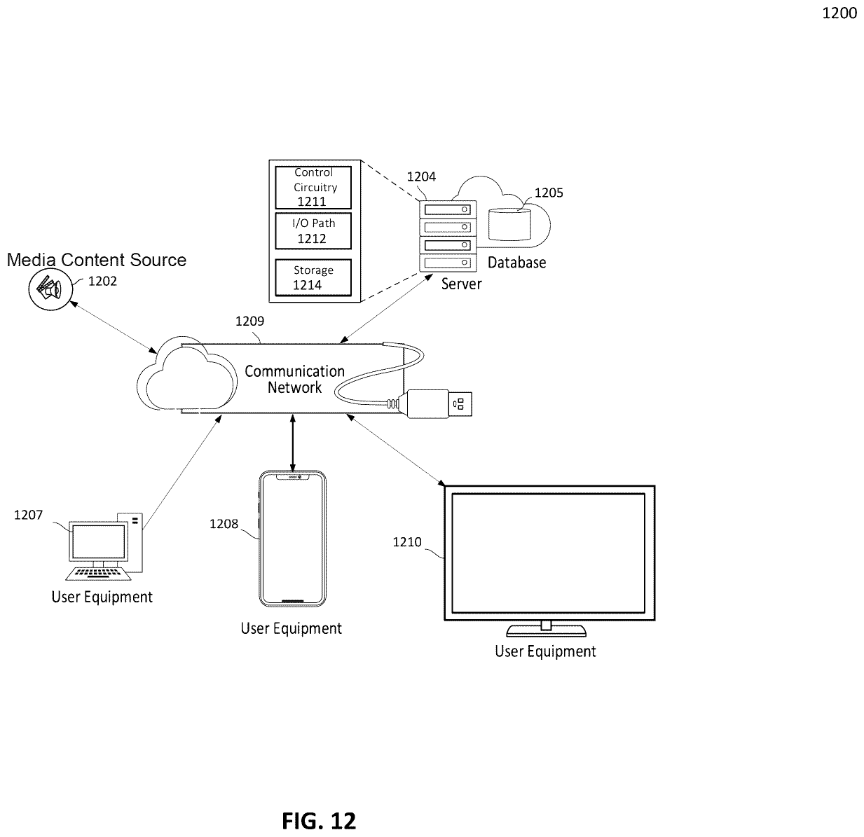

In some embodiments, the cloud service management server may receive at a simultaneous localization and mapping (SLAM) management server a request for a SLAM task from a task device. The request specifies a sensor requirement for the SLAM task, a schedule for the SLAM task, and a location constraint. The sensor requirement for the SLAM task may include any type of sensor used for SLAM that includes, but is not limited to an optical camera, an infrared camera, a heat camera, an accelerometer, a LIDAR, a RADAR, a SONAR, or an ultrasonic sensor. A task device may be any device that requires a SLAM task to be performed. In some variants, the task device may be a personal computer, a smart appliance, an extended reality (XR) device, a media server, a mobile phone, a tablet, an internet-of-things device, or any device having network connectivity and SLAM capacity. In some embodiments, the task device may be a robot dog, a robot appliance, a robotic device, a robotic drone, or a robot assistant. In some embodiments, the task device may be user equipment 1207, 1208, or 1210 in FIG. 12. For example, as shown in FIG. 1A, the task device may be a robot vacuum 102 that has an optical camera and an infrared camera to perform SLAM tasks (e.g., figure out the floorplan of a room to be vacuumed). The schedule for the SLAM task may be any temporal parameter in relation to the requested SLAM task having any type of temporal granularity. The location constraint may be any locational parameter in relation to the requested SLAM task having any type of locational granularity. Continuing from the earlier example, the request may specify that the SLAM hardware must have an optical camera and an infrared camera during 9:00 PM and 11:00 PM on August 3, and be proximate to the house in Santa Cruz, California (e.g., within two mile radius of the Santa Cruz city limits).

In some embodiments, the cloud service management server may access, via a network operating on a 6G protocol, for a vehicle, a sensor capability of a SLAM subsystem of the vehicle, a location of the vehicle, and a history of availability of the vehicle for providing SLAM tasks. In some embodiments, the vehicle may be user equipment 1207, 1208, or 1210. The network may operate on a 6G protocol. The intersection of 6G and SLAM provides for many benefits, especially as 6G aims to enhance machine type communications and ultra-reliable low-latency communications. 6G's potential for higher data rates and lower latency can facilitate more sophisticated SLAM algorithms by allowing devices to quickly transmit detailed sensor data to cloud platforms for processing, then receive precise navigation instructions back in real-time. Additionally, remote operation of robots and drones using SLAM technology over 6G networks could become more feasible and efficient, as operators can manage and navigate these devices in real-time with minimal latency, even over long distances. In scenarios where multiple robots are operating in the same space (like warehouses or on manufacturing floors), 6G can enable a more efficient exchange of mapped data and positional information, improving collective navigational accuracy and operational efficiency. Note this is relevant for the robot vacuum example. Moreover, as SLAM is essential for AR/VR/MR applications to accurately overlay digital content onto the real world, 6G may enhance these experiences by ensuring that data transfer and processing happen almost instantaneously, making the virtual interactions more seamless and realistic. Returning to FIG. 1A, at 106, the cloud service management server accesses the communication network operating on a 6G protocol.

In some embodiments, the cloud service management server may access, via a network operating on a 6G protocol, for a vehicle, a sensor capability of a SLAM subsystem of the vehicle, a location of the vehicle, and a history of availability of the vehicle for providing SLAM tasks. The sensor capability of the SLAM subsystem may be accessed by the cloud service management server via system information of the vehicle through a communications interface. A current location may be any data that describes location such as GPS coordinates, city or town name, street address, postal code, location data via triangulation of sensors, connected mobile tower or any other type of locational data. Respective location history may also be accessed via a vehicle database that stores all vehicle related information including respective location history. Respective history of availability may be accessed by the cloud service management server via system information of the vehicle through a communications interface. Respective history of availability for providing SLAM tasks may also be determined based on a vehicle database that stores all vehicle related information including history of availability. Returning to FIG. 1A, at 104, the cloud service management server accesses vehicle 1 status, location, location history, and SLAM system availability. The data may show vehicle 1 is currently in charging status and it is located within the house garage. Vehicle 1 is typically in the house from 6:00 PM-6:00 AM. The SLAM system is available during charge status. In some embodiments, the respective history of availability of the vehicle may be accessed by the cloud service management server via a database (e.g., 1205 in FIG. 12). For example, the table below illustrates a data structure including history of availability data for a vehicle:

TABLE
History of Availability Data for Vehicle n

| Date/Time | Location(s) | Status |
|---|---|---|
| Aug. 8, 2024 | 500-598 Santa Cruz St, Santa Cruz | Charging |
| 11:00 p.m.-7:00 a.m. | CA 95060 | |
| Aug. 9, 2024 | 1116 Pacific Ave, Santa Cruz, CA | Parked (not |
| 7:00 a.m.-9:00 p.m. | 95060 | charging) |
| Aug. 8, 2024 | 500-598 Santa Cruz St, Santa Cruz | Charging |
| 9:00 p.m.-6:55 a.m. | CA 95060 | |
| Aug. 8, 2024 | 1116 Pacific Ave, Santa Cruz, CA | Parked (not |
| 6:55 a.m.-5:00 p.m. | 95060 | charging) |
| Aug. 10, 2024 | 321 Central Ave, Pacific Grove, | Charging |
| 5:00 p.m.-9:00 p.m. | CA 93950 | |

In some embodiments, the cloud service management server may determine, based on the accessing, that the SLAM subsystem of the vehicle meets the sensor requirement for the SLAM task and that the vehicle is available to perform the SLAM task within a time period that complies with the schedule for the SLAM task and at a location meeting the location constraint. Returning to FIG. 1A, at 108, the cloud service management server analyzes the vehicle data to determine the SLAM subsystem of the vehicle meets the sensor requirement. FIG. 1B shows an illustrative scenario 120 where a cloud service management server determines, based on the accessing, whether the SLAM subsystem of the vehicle meets the sensor requirement for the SLAM task, in accordance with some embodiments of this disclosure. The data, 122, is reproduced as an embedded table below for convenience.

122

Vehicle 1 Status:
Tesla Model 3 Blue
6G connectivity
SLAM System Hardware Profile
1x Rear Camera
3x Front Camera
Accelerometer
Location:
Santa Cruz (proximate to house (<50 feet)
Historical (San Jose Jul. 4, 2024, Gilroy
Jul. 1, 2024)
SLAM System Availability:
4 hrs to full charge
Historical Data
Charges between 6:00PM-9:00PM on Mon-Fri
90% Confidence
Charges between 9AM-12PM on Sat-Sun
70% Confidence

In some embodiments, the cloud service management server may determine, based on the accessing, that the SLAM subsystem of the vehicle meets the sensor requirement for the SLAM task, but that the vehicle is not available to perform the SLAM task within a time period that complies with the schedule for the SLAM task. In this scenario, the cloud service management server may schedule the SLAM task at an alternate timing that is consistent with the availability of the vehicle. For example, if the preferred timing was between 10:00 PM-12:00 AM, but the vehicle is not available until 1:00 AM, the cloud service management server may alter the schedule to 1:00 AM. In some embodiments, the alteration of the schedule may require confirmation from the task device to proceed. In some embodiments, the alteration of the schedule may require confirmation of a timing threshold for the schedule to allow for the SLAM task to proceed at an altered schedule (e.g., a timing threshold of plus or minus 4 hours). For example, the cloud service management server may receive a schedule threshold value that permits deviation of the time period by the threshold value (e.g., plus or minus 4 hours). The deviation of the time period is the deviated time period. The cloud service management server may then, in response to determining that the vehicle is not available to perform the SLAM task within the time period, determine that the vehicle is available to perform the SLAM task within the deviated time period.

In response to the determining (based on the accessing), the cloud service management server may then cause the SLAM subsystem of the vehicle to be configured for the SLAM task based on requirements of the task device. FIG. 1C shows an illustrative scenario 130 where a cloud service management server causes the SLAM subsystem to be configured for the SLAM task, in accordance with some embodiments of this disclosure. At 132, the cloud service management server determines that vehicle 1 is capable of performing the SLAM task. The cloud service management server may cause the SLAM subsystem of vehicle 1 to be configured for the SLAM task. For example, at 134, the cloud service management server may configure a processing module of vehicle 1 for the optical camera data and configure another processing module of vehicle 1 for the infrared camera data. At 136, the cloud service management server may then allocate at least one network slice on the network for sensor streams from the task device to the vehicle. For example, the cloud service management server may allocate one network slice for a first sensor stream transmitting data from vehicle 1 to the optical camera receiver on the robot vacuum. The cloud service management server may also allocate the same network slice for a second sensor stream transmitting data from vehicle 1 to the infrared camera receiver on the robot vacuum.

The cloud service management server may then configure the task device to stream sensor data from local sensors of the task device to the SLAM subsystem of the vehicle via the allocated at least one network slice. Continuing with the example, at 138, the sensor data from the robot vacuum is provided to the SLAM subsystem of vehicle 1 via the network slice operating on a 6G protocol 139. In some embodiments, the network operating on a 6G protocol may be implemented within the communication network 1209 in FIG. 12. In other embodiments, the vehicle is configured to stream the computed SLAM data computed by the SLAM subsystem of the vehicle to the task device via a different allocated network slice than the allocated at least one network slice. For example, in FIG. 1C, the allocation of the network slice would be performed at 136. In a scenario, if the bandwidth required for receiving the sensor streams is large, but the bandwidth required for transmitting sensor data is significantly smaller, then the cloud service management server may allocate a different network slice that has less bandwidth to preserve a high bandwidth network slice for other optimal usage.

The cloud service management server may then configure the vehicle to input the sensor data from local sensors of the task device into the SLAM subsystem of the vehicle to compute SLAM data for the task device. Continuing with our example, the cloud service management server configures vehicle 1 to input the sensor data from the optical camera and infrared camera of the robot vacuum into the SLAM subsystem of vehicle 1 to compute the SLAM data.

In some embodiments, the vehicle is configured to stream the computed SLAM data computed by the SLAM subsystem of the vehicle to the task device via the allocated at least one network slice. Continuing with the example, at 142, once vehicle 1 has computed the SLAM data, this SLAM data is transmitted to the robot vacuum via the 6G network slice. This network slice is the same network slice that was used to transmit the sensor streams from the task device to the vehicle.

In some embodiments, when the sensor data is streamed from local sensors of the task device to the SLAM subsystem of the vehicle, a quality-of-service threshold may not be met. The cloud service management server may receive a determination from the vehicle that a particular sensor stream of the plurality of sensor streams does not meet a quality-of-service threshold for the SLAM subsystem. The quality-of-service threshold may be a preset parameter, or a dynamic parameter based on the SLAM subsystem of the vehicle used. In FIG. 1C, the receiving of the determination that the quality-of-service does not meet the threshold may be received at 138. For example, if the vehicle's SLAM subsystem receives an optical camera feed from the robot vacuum in 720p resolution; this may not be sufficiently high quality enough to determine the SLAM data. The cloud service management server may cause the task device to transmit the particular sensor stream with higher quality. Continuing with the example, the cloud service management server, recognizing that 720p does not meet the quality-of-service threshold of 1080p, transmits a request to the robot vacuum to send higher quality optical feed at minimum 1080p. Similar quality-of-service thresholds may be measured related to framerate, bitrate, and other video quality metrics. For example, is the robot vacuum has capability to capture video at 1080p @ 60 Hz HEVC 6 Mbps that would leverage the network Slice NEF and PCF, the cloud service management server may request upscaling of the video quality from the current receipt of 720p @ 60 Hz HEVC 3 Mbps to increase in bandwidth to 6 Mbps and to the client device to encode 1080p@60 Hz at 6 Mbps.

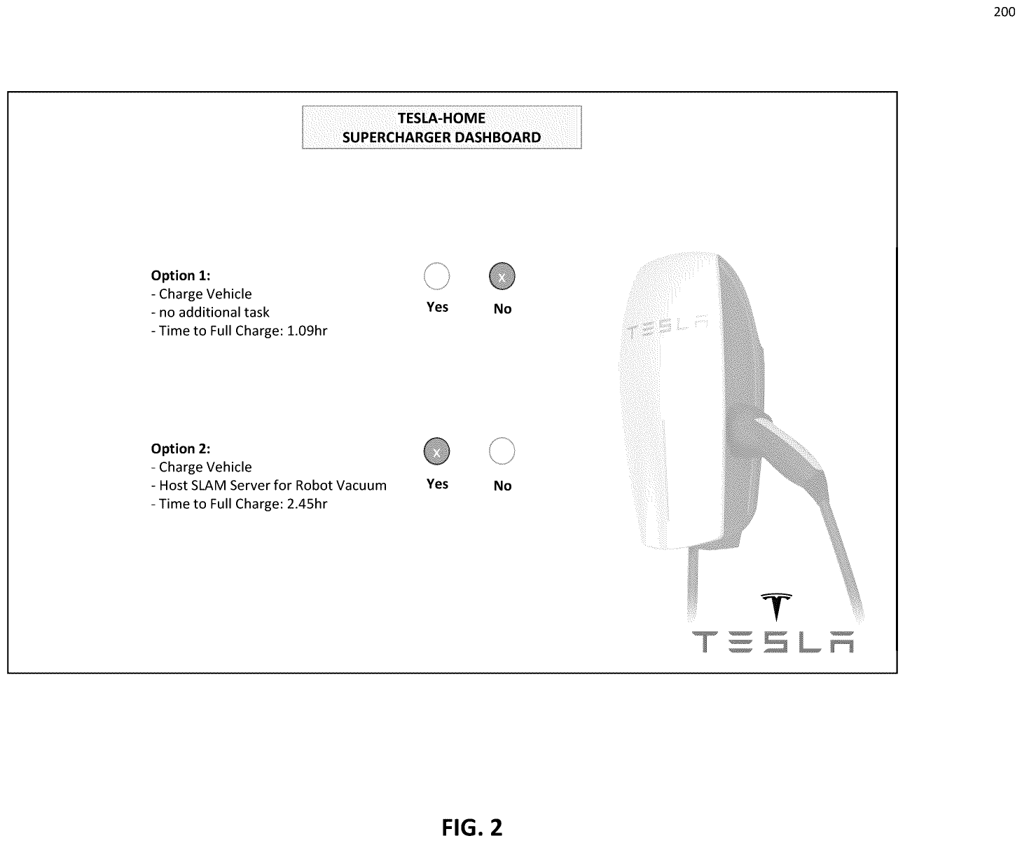

In some embodiments, the cloud service management server may generate for display a user-interface for a vehicle charging station. The user interface may include (a) a first option to charge, at a normal charging rate, a vehicle of the plurality of vehicles without performing the SLAM task, and (b) a second option to charge, at a reduced charging rate relative to the normal charging rate, the vehicle of the plurality of vehicles and performing the SLAM task. FIG. 2 shows an illustrative scenario 200 of a home vehicle charger dashboard, in accordance with some embodiments of this disclosure. The dashboard has two options for selection with respect to the vehicle. Option 1 indicates that the vehicle will be charged with no additional task and the time to full charge is 1.09 hours. Alternatively, option 2 provides for the vehicle to be charged, but also to host a gaming server with the time to full charge extending to 2.45 hours. The cloud service management server may receive an input confirming selection of the second option from the vehicle. For example, confirmation receipt of input may be received at 104 in FIG. 1A. The cloud service management server may receive an input confirming selection of second option from the vehicle. Continuing with the example in FIG. 2, option 2 is selected to charge the vehicle and host the gaming server. In some embodiments, the cloud service management server may determine the computing set of the plurality of vehicles is available to perform the SLAM task based on whether the vehicle is available to perform the SLAM task based on the receiving of the input from the vehicle confirming selection of the second option. For example, only if option 2 is selected, the vehicle would be included in the computing set. In some embodiments, the cloud service management server may access a selection history for the vehicle that includes historical option selection from the user-interface for the vehicle charging station. The cloud service management server may then determine whether the selection history for the vehicle exceeds a second option threshold. The second option threshold is a probability that the second option is more often selected than the first option. In some embodiments, the cloud service management server may receive instruction from the user-interface to schedule a SLAM task within the time for vehicle charging, set availability preferences, opt in or out of the service, and monitor the performance and earnings from their participation. In some embodiments, the user interface provides information with respect to the computing resources that are used for SLAM tasks, including setting availability preferences, and viewing the benefits or compensations derived from their participation.

In some embodiments, the cloud service management server may receive a selection for the user-interface for the vehicle that schedules a future SLAM task at a later time than the received selection and at a future location. For example, the cloud service management server receives a selection that the robot vacuum is to clean the house tomorrow once the car is parked in the garage from 11:00 AM-12:00 PM. The cloud service management accesses, via the network operating on the 6G protocol, for the vehicle, the sensor capability of a SLAM subsystem of the vehicle, the location of the vehicle, and the history of availability of the vehicle for providing the future SLAM. The cloud service management determines, based on the accessing, that the SLAM subsystem of the vehicle meets the sensor requirement for the future SLAM task and that the vehicle is available to perform the SLAM at the later time and at the future location. In response to the determining, the cloud service management causes the SLAM subsystem of the vehicle to be configured for the future SLAM task based on requirements of the task device and allocates at least one network slice on the network for the sensor streams from the task device to the vehicle. The task device may be configured to stream sensor data from local sensors of the task device to the SLAM subsystem of the vehicle via the allocated at least one network slice. The vehicle may be configured to input the sensor data from local sensors of the task device into the SLAM subsystem of the vehicle to compute SLAM data for the task device.

In some embodiments, the cloud service management server may determine whether the allocated at least one network slice on the network for sensor stream from the task device to the vehicle exceeds a bandwidth capacity threshold. In some embodiments, the bandwidth capacity threshold may be measured in real time of transferring data. In some embodiments, the bandwidth capacity threshold may be based on network configuration definitions (e.g., throughout specifications). In response to the determining that the allocated at least one network slice on the network for the sensor stream from the task device to the vehicle exceeds the bandwidth capacity threshold, the cloud service management server may allocate a new network slice on the network for the sensor streams. The new network slice may have a higher bandwidth capacity than the allocated at least one network slice. For example, the determining that the allocated at least one network slice on the network for the sensor stream from the task device to the vehicle exceeds the bandwidth capacity threshold may occur at 138 in FIG. 1C.

In some embodiments, the cloud service management server may leverage the onboard artificial intelligence (AI) and computing units within vehicles, specifically tailored for SLAM applications. The cloud service management server includes integrated sensors and software that monitor key vehicle parameters such as battery levels, internal temperature, vehicle location, and connectivity status. This data is crucial to ensure that the use of the vehicle's computing resources for SLAM processing does not interfere with its primary operational readiness. The system utilizes predictive analytics to anticipate periods when the vehicle will be parked and can safely engage in SLAM data processing. By analyzing historical data on vehicle usage patterns, including typical parking times and durations, the system predicts downtime periods when the vehicle's computing resources can be allocated to SLAM tasks. This predictive capability optimizes the utilization of the vehicle's onboard computing units, enhancing the efficiency of SLAM operations across various applications, such as enhancing geographic data systems or supporting autonomous vehicle fleet operations.

In some embodiments, the cloud service management server may dynamically select and configures network slices specifically for SLAM data traffic. The cloud service management server uses application programming interfaces (APIs) to communicate with network infrastructure, adjusting the bandwidth, latency, and security settings based on the real-time requirements of SLAM processing tasks. The APIs facilitate the dynamic management of network slices, ensuring that SLAM data processing is prioritized appropriately without impacting other critical vehicle functions or services. The cloud service management server network management component (NMC) interacts with the cloud-based SLAM service to determine the optimal network slice parameters.

In some embodiments, the cloud service management server may dynamically select and configure network slices specifically for SLAM data traffic. The cloud service management server uses network slicing application programming interfaces (NSAPIs) to communicate with network infrastructure, adjusting the bandwidth, latency, and security settings based on the real-time requirements of SLAM processing tasks. A NSAPI is used for network slicing in networking, where a single physical network can be divided into multiple virtual networks (slices). Each slice can be customized for different types of services with specific requirements (e.g., low latency for autonomous vehicles or high bandwidth for video streaming). The NSAPI provides an interface for applications to interact with different network slices, allowing them to request, modify, and terminate network slices as needed. The NSAPI may ensure that the appropriate network resources are allocated based on the requirements of the application. The network operator could run their own slices and also create slices for business like autonomous vehicle companies and edge computing/service companies, cloud gaming companies, etc. Each slice has its own network exposure function (NEF) 402 and policy control function (PCF) 404. A PCF may control network resource allocation based on predefined policies, subscriber data, and real-time conditions that may include managing quality of service (QoS), data usage, and other network policies. The PCF may ensure that network policies are consistently applied across all network slices and services, optimizing network performance and ensuring compliance with service level agreements (SLAs). The PCT may interact closely with other network functions like the access and mobility management function (AMF) and the session management function (SMF). A NEF allows external applications to access certain data from the cloud service management server. The NEF is a key component in the core network that exposes the capabilities and resources of the network to external applications and third-party services. The NEF acts as a secure gateway for external entities to access network services, providing mechanisms for authorization, traffic steering, and quality of service management. More specifically, the NEF may provide for access to analytics and performance data from the 6G slice. The NEF may also allow API calls to set parameters on traffic flows within that specific slice. The NEF plays a critical role in integrating various services with the network, ensuring that only authorized entities can access and modify network resources. It also collects and exposes network analytics, helping to optimize network performance and improve user experience.

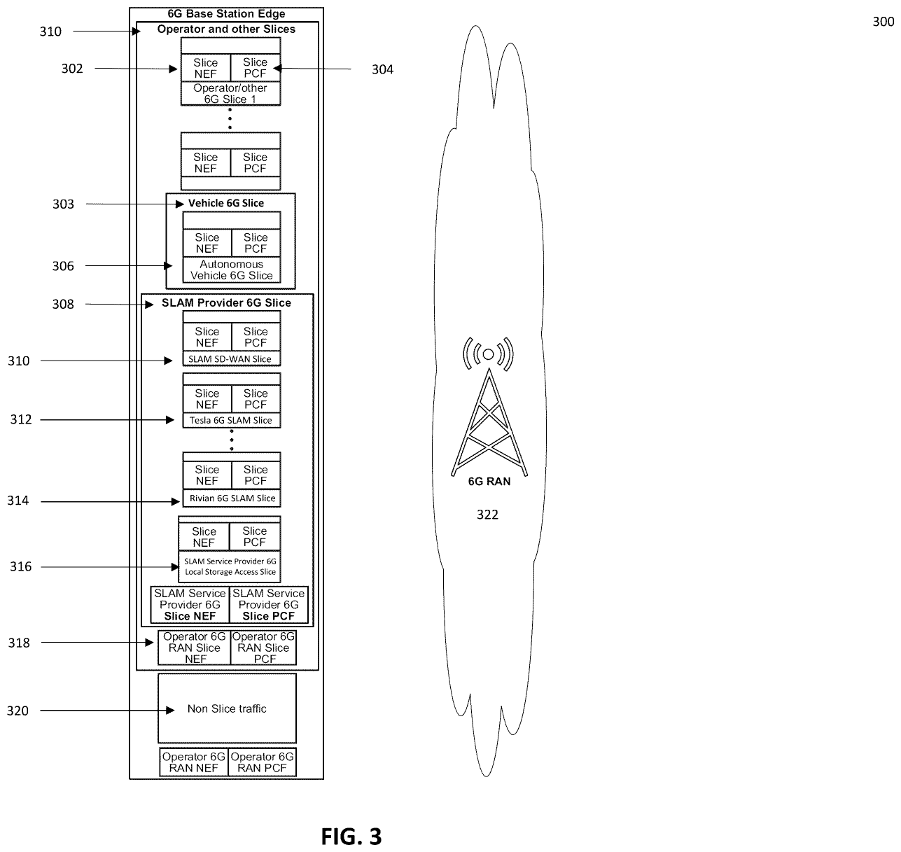

FIG. 3 shows an illustrative scenario 300 of a 6G Network Slice definition, in accordance with some embodiments of this disclosure. The 6G network may be implemented on communication network 1209 of FIG. 12. FIG. 3 illustrates the structure and components of a 6G Base Station Edge and its interaction with the 6G radio access network (RAN). The 6G Base Station Edge is divided into several sections, each representing different operators or specific use cases. The first section is labeled “Operator and other Slices” 310 and is divided into multiple 6G slices, each corresponding to different operators or specific use cases. For instance, the diagram shows “Operator/other 6G Slice 1,” which contains two sub-slices: Slice NEF (Network Exposure Function) 302 and Slice PCF (Policy Control Function) 304. There are multiple such operator slices, ranging from 6G Slice 1 to 6G Slice n. Following this, there is the “Vehicle 6G Slice” section 303, which is specifically designated for autonomous vehicles 306. This section contains Slice NEF and Slice PCF. The next part of the diagram is dedicated to “SLAM Provider 6G Slice,” 308 which is intended for SLAM service providers. This section is further divided into multiple sub-slices, including the SLAM SD-WAN Slice with Slice NEF and Slice PCF at 310, Tesla 6G SLAM Slice with Slice NEF and Slice PCF at 312, and Rivian 6G SLAM Slice with Slice NEF and Slice PCF at 314. Additionally, there is a “SLAM Service Provider 6G Local Storage Access Slice” that includes SLAM Service Provider 6G Slice NEF and SLAM Service Provider 6G Slice PCF at 316. Another section is the “Operator 6G RAN Slices,” 318 which includes slices specifically for 6G RAN traffic. This section contains the Operator 6G RAN Slice NEF and Operator 6G RAN Slice PCF. There is also a section allocated for non-slice traffic, which is managed separately within the base station at 320. At the bottom of the diagram, the Operator 6G RAN NEF/PCF is shown, representing generic NEF and PCF for operator 6G RAN traffic. On the right side of the diagram, a large symbol represents the 6G RAN at 322. This symbol is stylized with a tower and wireless signal lines emanating from it. The structure of the 6G Base Station Edge, with its various slices for handling different types of traffic and services, including operators, vehicles, and SLAM providers, allows for a highly modular and flexible approach to managing diverse traffic types and services in the 6G network. Each slice consists of NEF and PCF components, crucial for network exposure and policy control. The 6G RAN is a central component interfacing with the different slices to manage and facilitate communication.

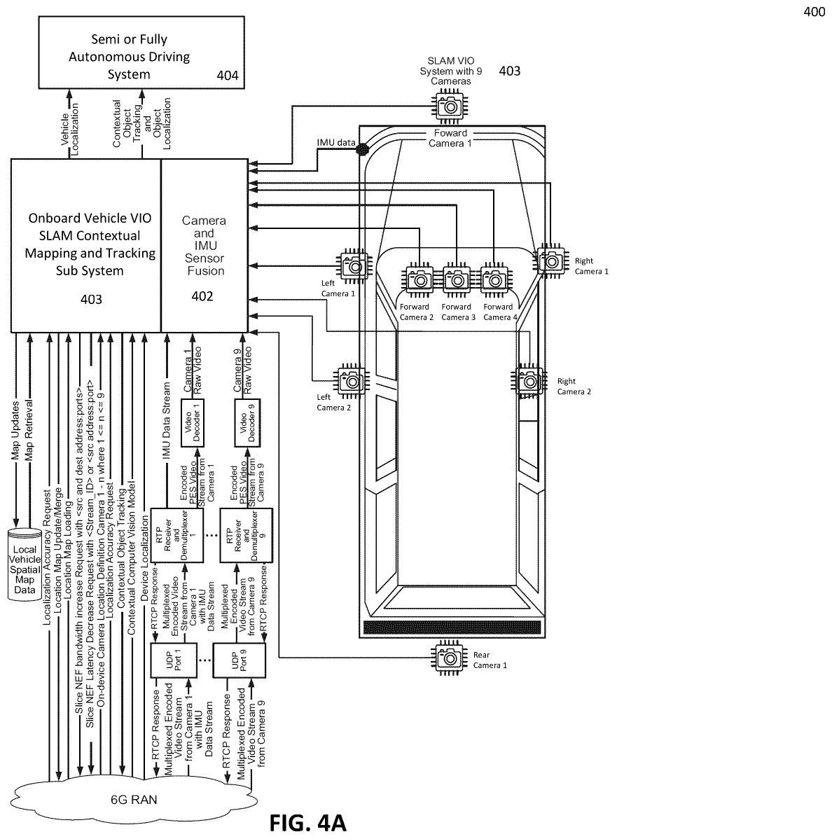

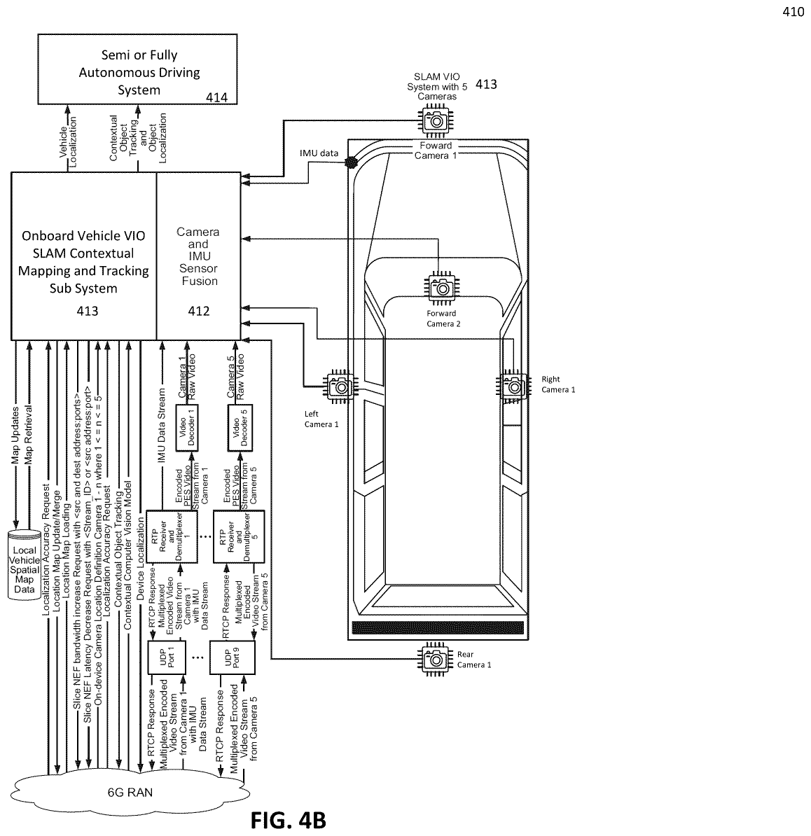

FIG. 4A shows an illustrative scenario 400 of a vehicle SLAM subsystem with nine cameras, in accordance with some embodiments of this disclosure. FIG. 4B shows an illustrative scenario 410 of another vehicle SLAM subsystem with five cameras, in accordance with some embodiments of this disclosure. These SLAM subsystems are designed to enable cloud-based SLAM functionality for semi or fully autonomous driving. FIG. 4A, the “SLAM VIO System with 9 Cameras” is depicted. This SLAM subsystem integrates multiple cameras 403 and IMU (Inertial Measurement Unit) sensor fusion 402 to provide raw video and IMU inputs. The vehicle is equipped with nine cameras, including Forward Camera 1, Forward Camera 2, Forward Camera 3, Forward Camera 4, Right Camera 1, Right Camera 2, Left Camera 1, Left Camera 2, and Rear Camera 1. When the car is acting on its own behalf (for example when it is autonomously driving), the cameras deliver raw video feeds while IMU data is concurrently collected. These inputs are processed by the Camera and IMU Sensor Fusion system 402, which merges the data and feeds the data into the SLAM subsystem 403 which provides SLAM functionality to the autonomous driving system (ADAS) 404. When the input comes from the network as opposed to the vehicle camera systems, the input from the network is processed by the SLAM subsystem and the localization and object tracking results are sent back to the originating device over the network slice. For example, this is a similar scenario to FIG. 1C where the vehicle 1 at 138 receives the SLAM task via the 6G network 139, computes the SLAM data and transmits the output 142 via 6G network over the network slice back to the robot vacuum (e.g., the task device). In FIG. 4B, the system includes five cameras (413) namely forward camera 1, forward camera 2, right camera 1, left camera 1, and rear camera 1. The process is consistent with the other systems, where IMU data and raw video inputs from the cameras are fused 412 and processed for contextual mapping, tracking, and vehicle localization or to provide SLAM functionality 413 for a client device over the mobile network 414 in a similar manner as described above.

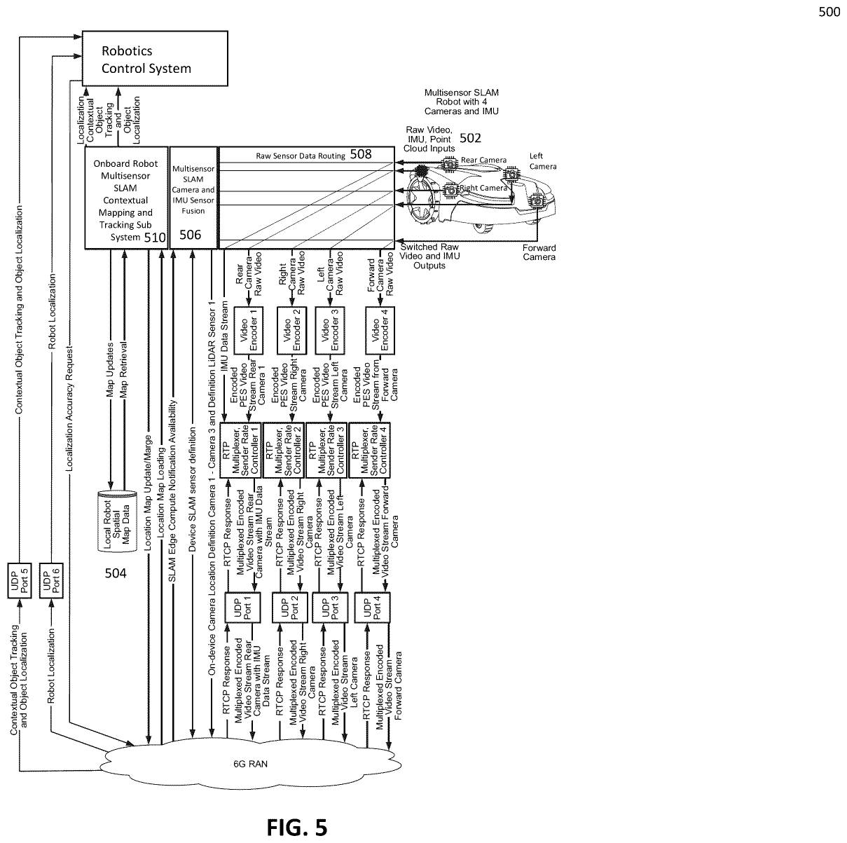

FIG. 5 shows an illustrative scenario 500 of a task device with a camera and IMU sensor, in accordance with some embodiments of this disclosure. The following SLAM subsystem illustrates a multi-sensor SLAM subsystem for a robot (e.g., task device) equipped with four cameras and an IMU (Inertial Measurement Unit) sensor at 506. The multi-sensor SLAM subsystem is designed to send sensor data over the network to be processed by the cloud service management server. For example, this is similar to the example in FIG. 1A where the task device is a robot vacuum 102. When operating in conjunction with a network-based SLAM system as described in embodiments above, raw sensor data is processed and encoded into multiple sensor streams shown at 508. Each camera's raw video feed and the IMU data are encoded and multiplexed through RTP (Real-time Transport Protocol) multiplexers and senders 502. These encoded video streams are sent over various UDP (User Datagram Protocol) ports (Port 1, Port 2, Port 3, and Port 4) to the 6G RAN (Radio Access Network). In addition to the camera and IMU data, the system supports various localization services. These services include localization accuracy request, local robot spatial map data retrieval 504, contextual object tracking and object localization, and/or edge compute notification availability. These services use different UDP ports (Port 5 and Port 6) to ensure comprehensive data communication and processing. For example, the network may be communication network 1209 shown in FIG. 12 with the same implementation of different UDP ports to ensure comprehensive data communication and processing. The combined data from the robot's sensors and the localization services enable the vehicle SLAM system to perform advanced mapping and tracking tasks on behalf of the robot's local SLAM system at 510.

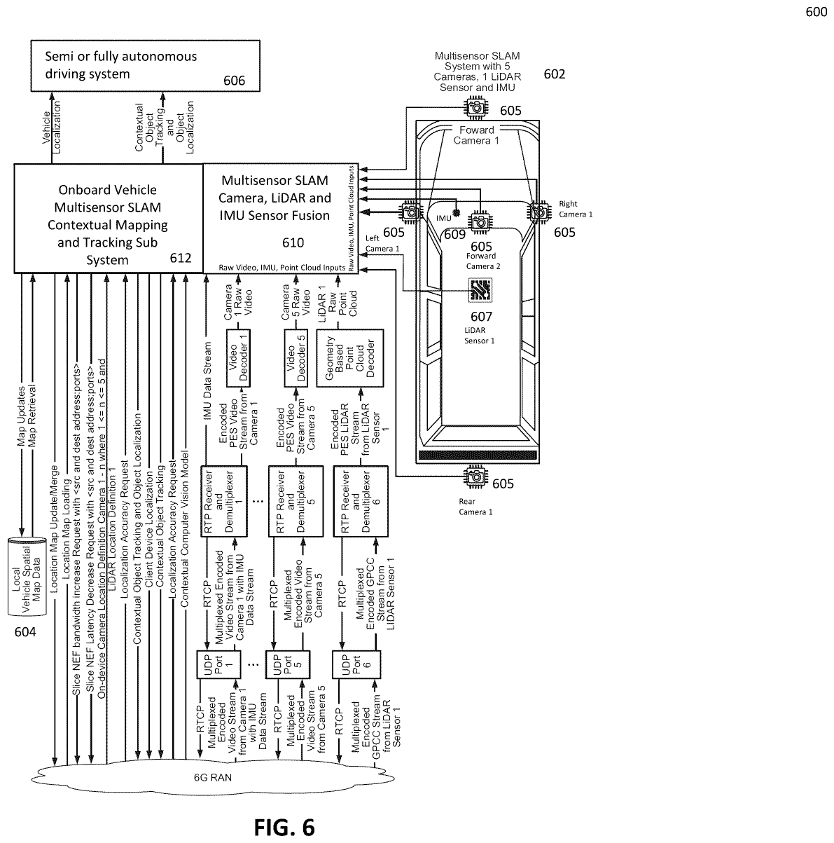

FIG. 6 shows an illustrative scenario 600 of a vehicle SLAM subsystem with multiple sensors, in accordance with some embodiments of this disclosure. The following SLAM subsystem illustrates a multi-sensor SLAM subsystem 602 designed for a vehicle equipped with five cameras (605), one LiDAR sensor 607, and an IMU (609). This SLAM subsystem is intended to leverage SLAM Mobile Edge Compute Service, enhancing semi or fully autonomous driving capabilities through cloud-based processing. On the right side, the “Multisensor SLAM System with 5 Cameras, 1 LiDAR Sensor and IMU” 602 is depicted. This vehicle is outfitted with five cameras: Forward Camera 1, Forward Camera 2, Right Camera 1, Left Camera 1, and Rear Camera 1. Additionally, there is a LiDAR Sensor 1 (in some embodiments, the LIDAR is integrated into a camera). The cameras provide raw video feeds at 610, the LiDAR sensor supplies point cloud data, and the IMU provides data on movement and orientation. The raw video from each camera, the LiDAR point cloud data, and the IMU data are routed through a raw sensor data routing system. The processed data is managed by the raw sensor data routing system, which forwards the raw video, LiDAR, and IMU data to the semi or fully autonomous driving system at 606. This multi-sensor SLAM subsystem at 612 handles vehicle localization, contextual object tracking, and object localization. It also manages cloud inputs, ensuring that raw video, IMU data, and point cloud inputs are efficiently transmitted. When operating in conjunction with a network-based SLAM system as described in embodiments above, raw sensor data is then encoded into multiple data streams. Each camera's raw video feed, the LiDAR data, and the IMU data are encoded and multiplexed through RTP (Real-time Transport Protocol) receivers and demultiplexers. These encoded streams are sent over various UDP (User Datagram Protocol) ports (Port 1, Port 5, and Port 6) to the 6G RAN (Radio Access Network). For example, the network may be communication network 1209 shown in FIG. 12 with the same implementation of different UDP ports and 6G RAN. In addition to the raw sensor data, the system supports various localization services, including localization accuracy request, local vehicle spatial map data retrieval 604, contextual object tracking and object localization, and/or edge compute notification availability. These services use different UDP ports to ensure comprehensive data communication and processing. The combined data from the vehicle's sensors and the localization services enable the multi-sensor SLAM subsystem to perform advanced mapping and tracking tasks.

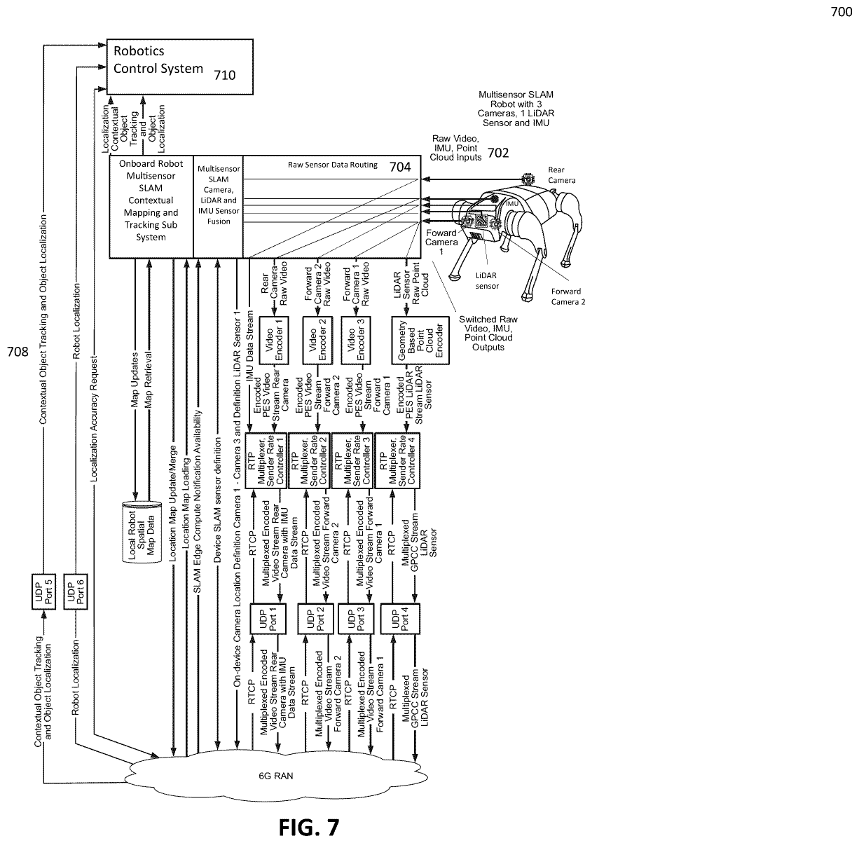

FIG. 7 shows an illustrative scenario 700 of a robot dog SLAM subsystem, in accordance with some embodiments of this disclosure. The following SLAM subsystem illustrates a robotic device (e.g., task device that is a robot dog) with multi-sensor sensors including cameras, LiDAR, and IMU at 702. This robotic SLAM subsystem is equipped with multiple sensors that enhance its operational capabilities, including three cameras (forward, rear, and an additional camera labeled “Camera 1”), a LiDAR sensor, and an Inertial Measurement Unit (IMU). The raw video from each camera, the LiDAR point cloud data, and the IMU data are routed through a raw sensor data routing system at 704. The processed data is managed by the raw sensor data routing system, which forwards the raw video, LiDAR, and IMU data to the System 710. This system handles robot localization, contextual object tracking, and object localization at 708. It also manages cloud inputs, ensuring that raw video, IMU data, and point cloud inputs are efficiently transmitted. When operating in conjunction with a network-based SLAM system as described in embodiments above, raw sensor data is then encoded into multiple data streams. Each camera's raw video feed, the LiDAR data, and the IMU data are encoded and multiplexed through RTP (Real-time Transport Protocol) receivers and demultiplexers. These encoded streams are sent over various UDP (User Datagram Protocol) ports (Port 1, Port 2, Port 3 and Port 4) to the 6G RAN (Radio Access Network). For example, the network may be communication network 1209 shown in FIG. 12 with the same implementation of different UDP ports, 6G RAN, and RTP.

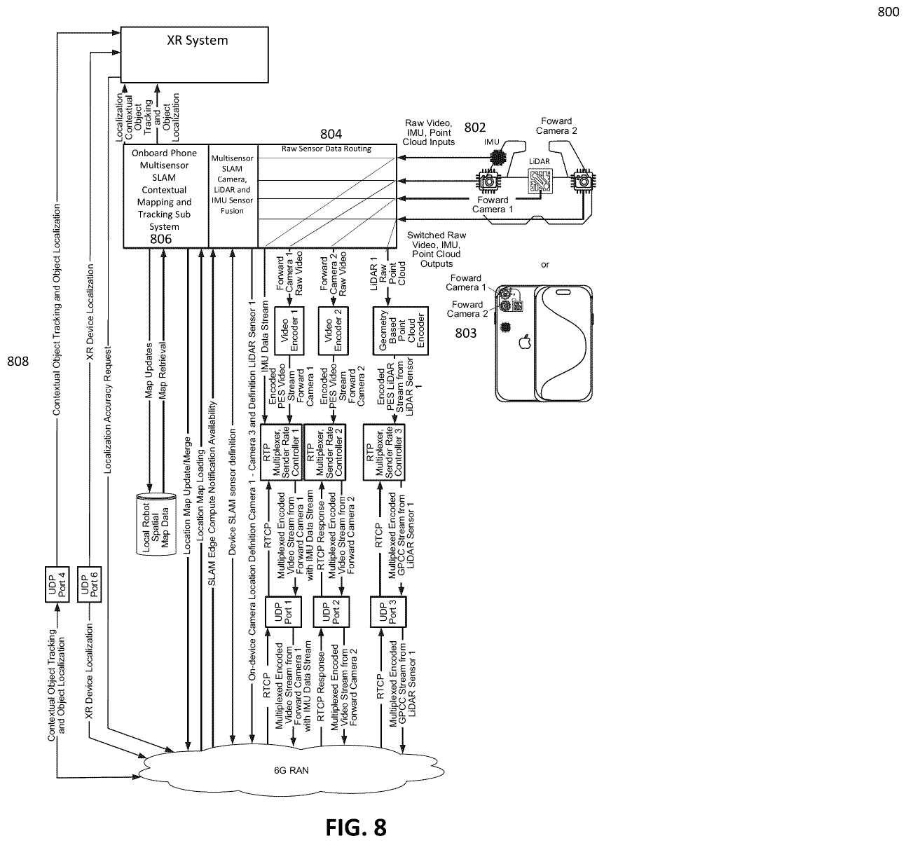

FIG. 8 shows an illustrative scenario 800 of a XR device SLAM subsystem, in accordance with some embodiments of this disclosure. The XR system is equipped with multiple sensors that enhance its operational capabilities, including two dedicated SLAM cameras, a LiDAR sensor, and an IMU at 802. In another embodiment, the system may be a smartphone having two forward cameras at 803. The raw video from each camera, the LiDAR point cloud data, and the IMU data are routed through a raw sensor data routing system at 804. The processed data is managed by the onboard phone multi-sensor SLAM contextual mapping and tracking subsystem 806, which forwards the raw video, LiDAR, and IMU data to the XR System. This XR SLAM subsystem handles XR device localization, contextual object tracking, and object localization at 808. It also manages cloud inputs, ensuring that raw video, IMU data, and point cloud inputs are efficiently transmitted. When operating in conjunction with a network-based SLAM system, raw sensor data is then encoded into multiple data streams. Each camera's raw video feed, the LiDAR data, and the IMU data are encoded and multiplexed through RTP (Real-time Transport Protocol) receivers and demultiplexers. These encoded streams are sent over various UDP ports (Port 1, Port 2, Port 3, Port 4, and Port 6) to the 6G RAN. For example, in FIG. 1C, at 138, vehicle 1 may receive the SLAM data over multiple sensor streams via one or more network slices from the 6G network 139.

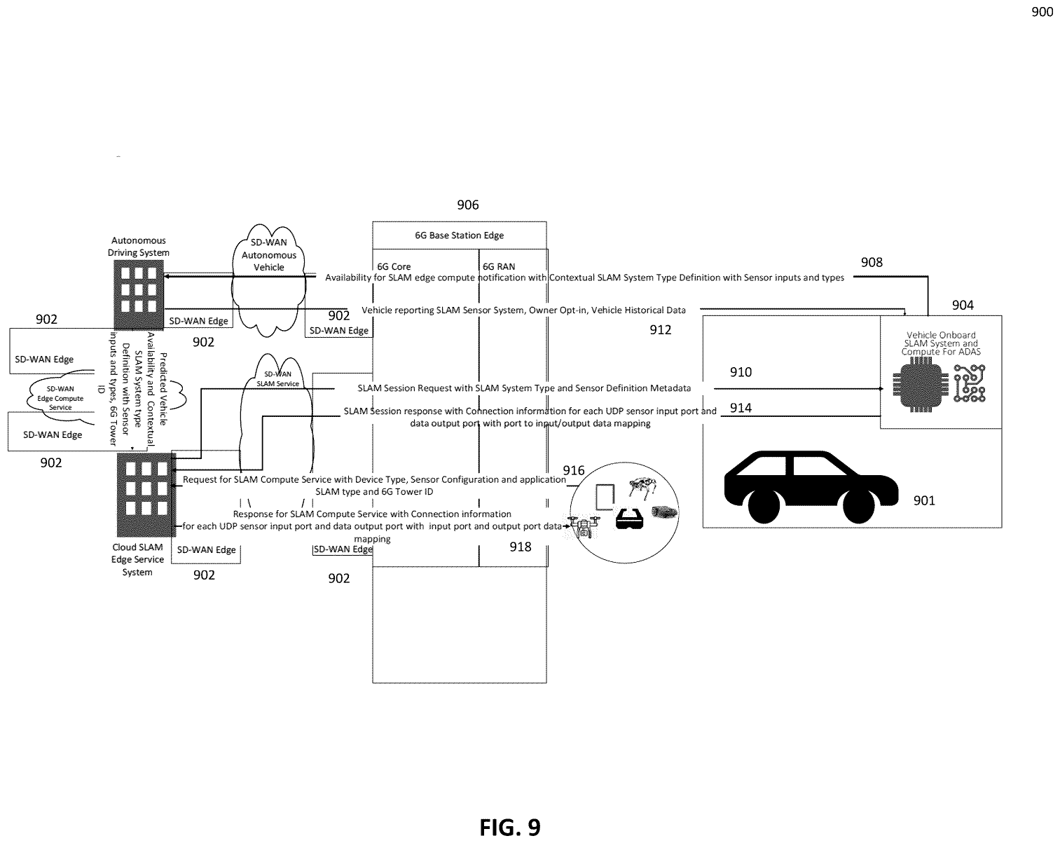

FIG. 9 shows an illustrative scenario 900 of dedicated SD-WANs for SLAM tasks, in accordance with some embodiments of this disclosure. This SLAM subsystem integrates various components to enhance the operational capabilities of autonomous vehicles through dedicated SD-WANs (Software-Defined Wide Area Networks) and 6G connectivity. For example, the network may be communication network 1209 shown in FIG. 12 with the same implementation of SDWANs. The autonomous driving system, for the vehicle 901, includes an autonomous vehicle equipped with an SD-WAN connected edge 902 and an onboard SLAM system for ADAS (Advanced Driver-Assistance Systems) 904. The vehicle communicates with a 6G base station edge 906, which ensures availability for SLAM edge compute services at 908. The 6G core and 6G RAN notify the system with contextual SLAM system type definitions, including sensor inputs and types at 910. The vehicle reports SLAM sensor system information, owner opt-in status, and vehicle historical data to the 6G base station 912. A SLAM session request is initiated with the SLAM system type and sensor definition metadata. The response provides connection information for each UDP sensor input port and data output port, mapping the input/output data accordingly 914. The cloud SLAM edge service system handles requests for SLAM compute services, detailing the device type, sensor configuration, application SLAM type, and 6G tower ID 916. The cloud system then provides a response with connection information for each UDP sensor input port and data output port, ensuring proper data mapping for efficient communication and processing at 918. This setup includes an SD-WAN edge compute service to manage and route data between the autonomous vehicle and the cloud SLAM edge service system. The architecture of the SLAM subsystem supports various device types, including autonomous vehicles, robots, and XR devices.

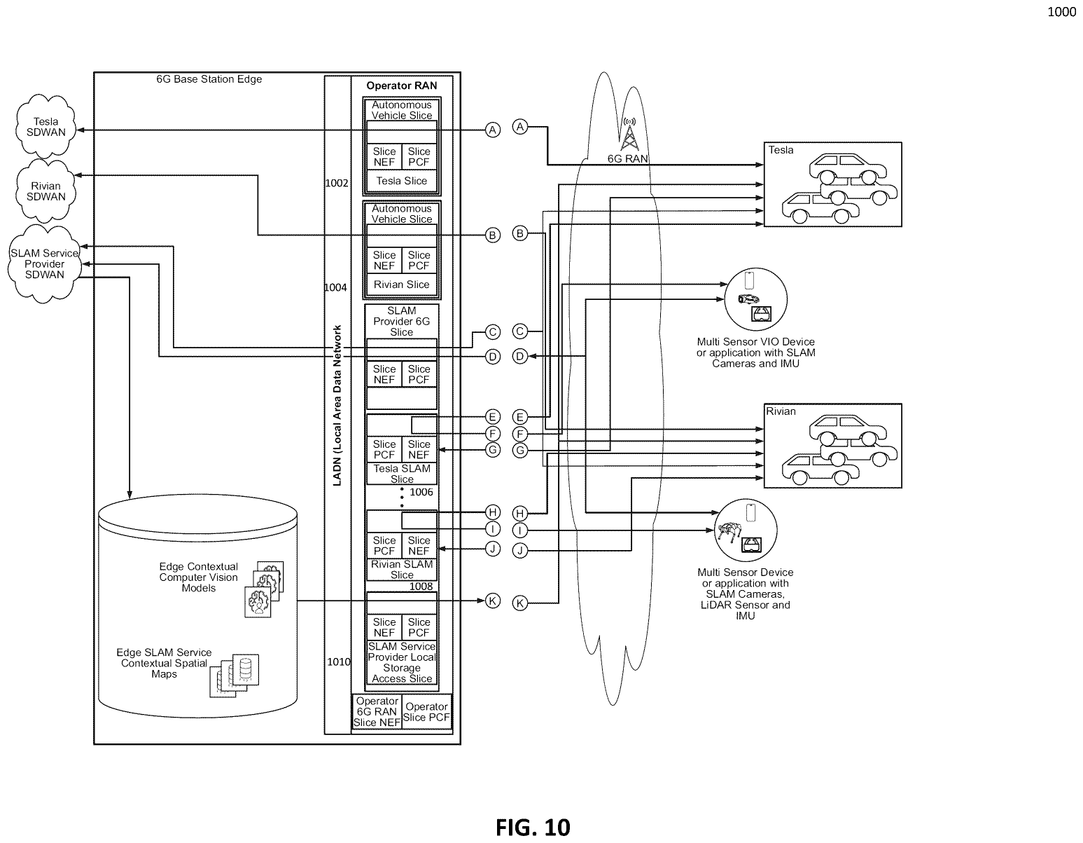

FIG. 10 shows an illustrative scenario 1000 of SLAM interfaces over the 6G network implementing recursive network slicing, in accordance with some embodiments of this disclosure. This SLAM subsystem integrates various components to enhance the operational capabilities of autonomous vehicles through dedicated SDWANs and 6G connectivity. For example, the network may be communication network 1209 shown in FIG. 12 with the same implementation of API calls to SLICE NEF where each service provider may have a preset allocated network slice. The autonomous vehicles demonstrate the dedicated slices and interfaces between the devices and the vehicles covering the SLAM service. The clients are directed to the dedicated slices (e.g., 1002, 1004, 1010) depending on the SLAM system that is required. If a device needs better localization accuracy or faster localization updates, the device may make a request to the vehicle providing the SLAM service for a localization accuracy request or a faster localization update. If the vehicle receives such a request, an API call to the SLICE NEF (Network Exposure Function) is made to increase bandwidth to a specific Mbps or decrease latency in μs. Each network slice may have the following attributes as shown in the table below:

### Network Slice Attributes (Relating to FIG. 10)

| Network Slice | Attributes |
|---|---|
| Rivian SLAM Slice | Device Localization |
| 1008 | Contextual Object Tracking and Object |
| | Localization |
| | On-device Camera Location Definition Camera |
| | LiDAR Location Definitions |
| | Localization Accuracy Request |
| | RTCP |
| | Multiplexed Encoded Video Stream from |
| | Camera 1 with IMU - Camera n where 1 <= n |
| | <=number of inputs allowed for cameras from |
| | Sensor Fusion on vehicle and n is the number |
| | of sensors on device or required by application |
| | Multiplexed Encoded GPCC Stream from LiDAR |
| | Sensor 1 - LiDAR Sensor n where 1 <= n<= |
| | number of inputs allowed from LiDAR Sensor |
| | Fusion on vehicle and n is the number of LiDAR |
| | sensors on device or required by application |
| Rivian SLAM | PCF Latency Increase/Decrease |
| Slice/Specific APIs | Request with <src and dest address:ports> |
| Slice | Slice PCF Bandwidth Increase/Decrease |
| | Request with <src and dest address:ports> |
| Tesla SLAM Slice | Device Localization |
| 1006 | Contextual Object Tracking and Object |
| | Localization |
| | On-device Camera Location Definition Camera |
| | LiDAR Location Definitions |
| | Localization Accuracy Request |
| | RTCP |
| | Multiplexed Encoded Video Stream from |
| | Camera 1 with IMU - Camera n where 1 <= n <= |
| | number of inputs allowed for cameras from |
| | Sensor Fusion on vehicle and n is the number of |
| | sensors on device or required by application |
| Tesla SLAM Slice | Slice PCF Latency Increase/Decrease Request |
| Specific APIs Slice | with <src and dest address:ports> |
| | Slice PCF Bandwidth Increase/Decrease Request |
| | with <src and dest address:ports> |
| SLAM Service | Location Map and CV Model Load |
| Provider Local Storage | Location Map Update/Merge |
| Access Slice 1010 | |
| Autonomous Vehicle | Availability for SLAM edge compute notification |
| Manufacturer's | with Contextual SLAM System Type |
| Slice | Definition with Sensor inputs and types |
| | Vehicle reporting SLAM Sensor System, Owner |
| | Opt-in, Vehicle Historical Data |
| SLAM SD-WAN Slice | Request for SLAM Compute Service with Device |
| (SLAM Client) | Type, Sensor Configuration and application |
| | SLAM type and 6G Tower ID |
| | Response for SLAM Compute Service with |
| | Connection information for each UDP sensor |
| | input port and data output port with input port |
| | and output port data mapping |
| SLAM SD-WAN Slice | Request for SLAM Compute Service with Device |
| (Vehicle) | Type, Sensor Configuration and application |
| | SLAM type and 6G Tower ID |
| | Response for SLAM Compute Service with |
| | Connection information for each UDP sensor |
| | input port and data |
| | output port with input port and output port |
| | data mapping |
| SLAM Service | Contextual Computer Vision Models |
| Provider's Edge | |
| Storage Interface | |

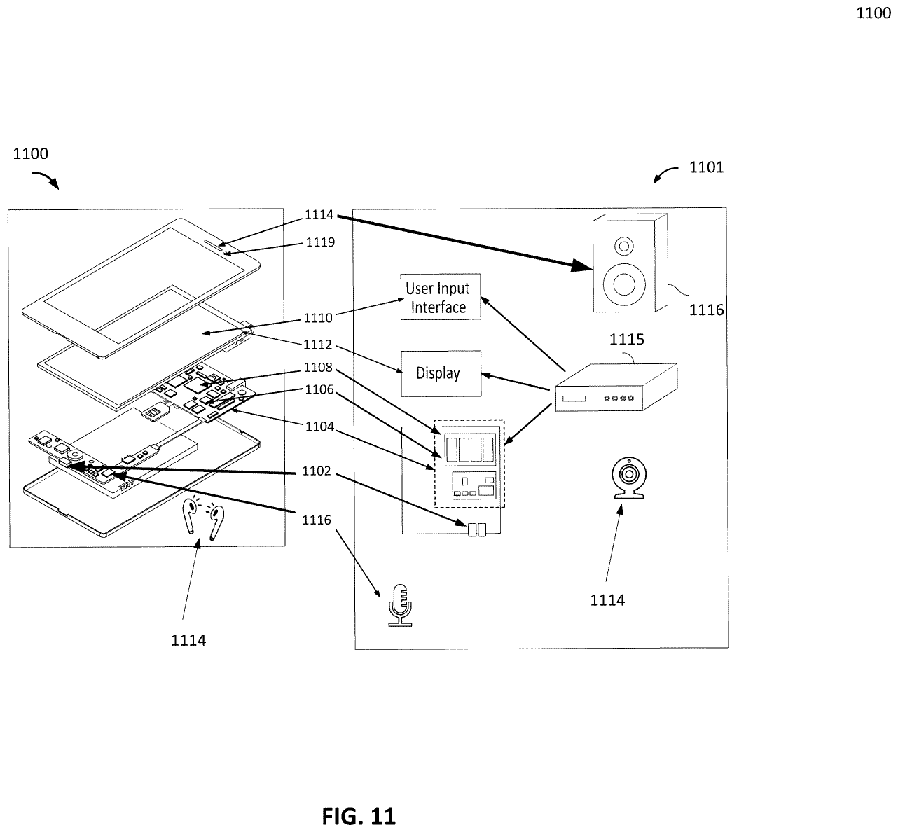

FIGS. 11-12 describe illustrative devices, systems, servers, and related hardware for a media application for processing and executing spoiler prevention for non-linear media. FIG. 11 shows generalized embodiments of illustrative user devices 1100 and 1101. For example, user equipment device 1100 may be a smartphone device, a tablet, smart glasses, a virtual reality or augmented reality device (e.g., AR goggles, AR headset, AR implemented via smartphone, tablet, or computer), vehicle with processing and network capability, or any other suitable device capable of consuming media assets and capable of transmitting and receiving data over a communication network. In another example, user equipment device 1101 may be a user television equipment system or device. User television equipment device 1101 may include set-top box 1115. Set-top box 1115 may be communicatively connected to microphone 1116, audio output equipment (e.g., speaker or headphones 1114), and display 1112. In some embodiments, microphone 1116 may receive audio corresponding to a voice of a user, e.g., a voice command. In some embodiments, display 1112 may be a television display or a computer display. In some embodiments, set-top box 1115 may be communicatively connected to user input interface 1110. In some embodiments, user input interface 1110 may be a remote-control device. Set-top box 1115 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 11. In some embodiments, device 1100 may comprise any suitable number of sensors, as well as a GPS module (e.g., in communication with one or more servers and/or cell towers and/or satellites) to ascertain a location of device 1100.

Each one of user equipment device 1100 and user equipment device 1101 may receive content and data via input/output (I/O) path 1102. I/O path 1102 may provide content (e.g., broadcast programming, on-demand programming, Internet content, content available over a local area network (LAN) or wide area network (WAN), and/or other content) and data to control circuitry 1104, which may comprise processing circuitry 1106 and storage 1108. Control circuitry 1104 may be used to send and receive commands, requests, and other suitable data using I/O path 1102, which may comprise I/O circuitry. I/O path 1102 may connect control circuitry 1104 (and specifically processing circuitry 1106) to one or more communications paths (described below). I/O functions may be provided by one or more of these communications paths but are shown as a single path in FIG. 11 to avoid overcomplicating the drawing. While set-top box 1115 is shown in FIG. 11 for illustration, any suitable computing device having processing circuitry, control circuitry, and storage may be used in accordance with the present disclosure. For example, set-top box 1115 may be replaced by, or complemented by, a personal computer (e.g., a notebook, a laptop, a desktop), a smartphone (e.g., device 1100), a tablet, a network-based server hosting a user-accessible client device, a non-user-owned device, any other suitable device, or any combination thereof.

Control circuitry 1104 may be based on any suitable control circuitry such as processing circuitry 1106. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1104 executes instructions for the Media application stored in memory (e.g., storage 1108). Specifically, control circuitry 1104 may be instructed by the Media application to perform the functions discussed above and below. In some implementations, processing or actions performed by control circuitry 1104 may be based on instructions received from the Media application.

In client/server-based embodiments, control circuitry 1104 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 12, the instructions may be stored in storage 1108, and executed by control circuitry 1104 of a device 1100.

In some embodiments, the media application may be a client/server application where only the client application resides on device 1100, and a server application resides on an external server (e.g., server 1204). For example, the media application may be implemented partially as a client application on control circuitry 1104 of device 1100 and partially on server 1204 as a server application running on control circuitry 1211. Server 1204 may be a part of a local area network with one or more of devices 1100 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 1204), referred to as “the cloud.” Device 1100 may be a cloud client that relies on the cloud computing capabilities from server 1204 to determine whether processing should be offloaded and facilitate such offloading. When executed by control circuitry 1104 or 1211, the media application may instruct control circuitry 1104 or 1211 circuitry to perform processing tasks for the client device and facilitate a media consumption session integrated with social network services. The client application may instruct control circuitry 1104 to determine whether processing should be offloaded.

Control circuitry 1104 may include communications circuitry suitable for communicating with a server, social network service, a table or database server, or other networks or servers The instructions for carrying out the above-mentioned functionality may be stored on a server (which is described in more detail in connection with FIG. 12). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 12). In addition, communications circuitry may include circuitry that enables peer-to-peer communication of user equipment devices, or communication of user equipment devices in locations remote from each other (described in more detail below).

Memory may be an electronic storage device provided as storage 1108 that is part of control circuitry 1104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1108 may be used to store various types of content described herein as well as media application data described above. Nonvolatile memory may also be used (e.g., to launch a boot-up routine and other instructions). Cloud-based storage may be used to supplement storage 1108 or instead of storage 1108.

Control circuitry 1104 may include video generating circuitry and adjustment circuitry, such as one or more analog tuners, one or more MPEG-2 decoders or other digital decoding circuitry, high-definition tuners, or any other suitable adjustment or video circuits or combinations of such circuits. Encoding circuitry (e.g., for converting over-the-air, analog, or digital signals to MPEG signals for storage) may also be provided. Control circuitry 1104 may also include scaler circuitry for upconverting and downconverting content into the preferred output format of user equipment 1100. Control circuitry 1104 may also include digital-to-analog converter circuitry and analog-to-digital converter circuitry for converting between digital and analog signals. The adjustment and encoding circuitry may be used by user equipment device 1100, 1101 to receive and to display, to play, or to record content. The adjustment and encoding circuitry may also be used to receive media consumption data. The circuitry described herein, including for example, the adjustment, video generating, encoding, decoding, encrypting, decrypting, scaler, and analog/digital circuitry, may be implemented using software running on one or more general purpose or specialized processors. Multiple tuners may be provided to handle simultaneous adjustment functions (e.g., watch and record functions, picture-in-picture (PIP) functions, multiple-tuner recording, etc.). If storage 1108 is provided as a separate device from user equipment device 1100, the adjustment and encoding circuitry (including multiple tuners) may be associated with storage 1108.

Control circuitry 1104 may receive instruction from a user by way of user input interface 1110. User input interface 1110 may be any suitable user interface, such as a remote control, mouse, trackball, keypad, keyboard, touch screen, touchpad, stylus input, joystick, voice recognition interface, or other user input interfaces. Display 1112 may be provided as a stand-alone device or integrated with other elements of each one of user equipment device 1100 and user equipment device 1101. For example, display 1112 may be a touchscreen or touch-sensitive display. In such circumstances, user input interface 1110 may be integrated with or combined with display 1112. In some embodiments, user input interface 1110 includes a remote-control device having one or more microphones, buttons, keypads, or any other components configured to receive user input or combinations thereof. For example, user input interface 1110 may include a handheld remote-control device having an alphanumeric keypad and option buttons. In a further example, user input interface 1110 may include a handheld remote-control device having a microphone and control circuitry configured to receive and identify voice commands and transmit information to set-top box 1115.

Audio output equipment 1114 may be integrated with or combined with display 1112. Display 1112 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1112. Audio output equipment 1114 may be provided as integrated with other elements of each one of device 1100 and equipment 1101 or may be stand-alone units. An audio component of videos and other content displayed on display 1112 may be played through speakers (or headphones) of audio output equipment 1114. In some embodiments, audio may be distributed to a receiver (not shown), which processes and outputs the audio via speakers of audio output equipment 1114. In some embodiments, for example, control circuitry 1104 is configured to provide audio cues to a user, or other audio feedback to a user, using speakers of audio output equipment 1114. There may be a separate microphone 1116 or audio output equipment 1114 may include a microphone configured to receive audio input such as voice commands or speech. For example, a user may speak letters or words that are received by the microphone and converted to text by control circuitry 1104. In a further example, a user may voice commands that are received by a microphone and recognized by control circuitry 1104. Camera 1118 may be any suitable video camera integrated with the equipment or externally connected. Camera 1118 may be a digital camera comprising a charge-coupled device (CCD) and/or a complementary metal-oxide semiconductor (CMOS) image sensor. Camera 1118 may be an analog camera that converts to digital images via a video card.

The media application may be implemented using any suitable architecture. For example, it may be a stand-alone application wholly implemented on each one of user equipment device 1100 and user equipment device 1101. In such an approach, instructions of the application may be stored locally (e.g., in storage 1108), and data for use by the application is downloaded on a periodic basis (e.g., from an out-of-band feed, from an Internet resource, or using another suitable approach). Control circuitry 1104 may retrieve instructions of the application from storage 1108 and process the instructions to provide media consumption and social network interaction functionality and generate any of the displays discussed herein. Based on the processed instructions, control circuitry 1104 may determine what action to perform when input is received from user input interface 1110. For example, movement of a cursor on a display up/down may be indicated by the processed instructions when user input interface 1110 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1104 may allow a user to provide user profile information or may automatically compile user profile information. For example, control circuitry 1104 may access and monitor network data, video data, audio data, processing data, participation data from a media application and social network profile. Control circuitry 1104 may obtain all or part of other user profiles that are related to a particular user (e.g., via social media networks), and/or obtain information about the user from other sources that control circuitry 1104 may access. As a result, a user can be provided with a unified experience across the user's different devices.

In some embodiments, the media application is a client/server-based application. Data for use by a thick or thin client implemented on each one of user equipment device 1100 and user equipment device 1101 may be retrieved on-demand by issuing requests to a server remote to each one of user equipment device 1100 and user equipment device 1101. For example, the remote server may store the instructions for the application in a storage device. The remote server may process the stored instructions using circuitry (e.g., control circuitry 1104) and generate the displays discussed above and below. The client device may receive the displays generated by the remote server and may display the content of the displays locally on device 1100. This way, the processing of the instructions is performed remotely by the server while the resulting displays (e.g., that may include text, a keyboard, or other visuals) are provided locally on device 1100. Device 1100 may receive inputs from the user via input interface 1110 and transmit those inputs to the remote server for processing and generating the corresponding displays. For example, device 1100 may transmit a communication to the remote server indicating that an up/down button was selected via input interface 1110. The remote server may process instructions in accordance with that input and generate a display of the application corresponding to the input (e.g., a display that moves a cursor up/down). The generated display may then be transmitted to device 1100 for presentation to the user.

In some embodiments, the media application may be downloaded and interpreted or otherwise run by an interpreter or virtual machine (run by control circuitry 1104). In some embodiments, the media application may be encoded in the ETV Binary Interchange Format (EBIF), received by control circuitry 1104 as part of a suitable feed, and interpreted by a user agent running on control circuitry 1104. For example, the media application may be an EBIF application. In some embodiments, the media application may be defined by a series of JAVA-based files that are received and run by a local virtual machine or other suitable middleware executed by control circuitry 1104. In some of such embodiments (e.g., those employing MPEG-2 or other digital media encoding schemes), the media application may be, for example, encoded and transmitted in an MPEG-2 object carousel with the MPEG audio and video packets of a program.

FIG. 12 is a diagram of an illustrative system 1200, in accordance with some embodiments of this disclosure. User equipment devices 1207, 1208, 1209, 1210 (e.g., user device; devices or any other suitable devices, or any combination thereof) may be coupled to communication network 1206. Communication network 1206 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1206) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The user equipment devices may also communicate with each other directly through an indirect path via communication network 1206.

System 1200 may comprise media content source 1202, one or more servers 1204, and one or more social network services. In some embodiments, the media application may be executed at one or more of control circuitry 1211 of server 1204 (and/or control circuitry of user equipment devices 1207, 1208, 1209, 1210.

In some embodiments, server 1204 may include control circuitry 1211 and storage 1214 (e.g., RAM, ROM, Hard Disk, Removable Disk, etc.). Instructions for the media application may be stored in storage 1214. In some embodiments, the media application, via control circuitry, may execute functions outlined in FIGS. 1-16. Storage 1214 may store one or more databases. Server 1204 may also include an input/output path 1212. I/O path 1212 may provide media consumption data, social networking data, device information, or other data, over a local area network (LAN) or wide area network (WAN), and/or other content and data to control circuitry 1211, which may include processing circuitry, and storage 1214. Control circuitry 1211 may be used to send and receive commands, requests, and other suitable data using I/O path 1212, which may comprise I/O circuitry. I/O path 1212 may connect control circuitry 1211 (and specifically control circuitry) to one or more communications paths. I/O path 1212 may comprise I/O circuitry.

Control circuitry 1211 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1211 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1211 executes instructions for an emulation system application stored in memory (e.g., the storage 1214). Memory may be an electronic storage device provided as storage 1214 that is part of control circuitry 1211.

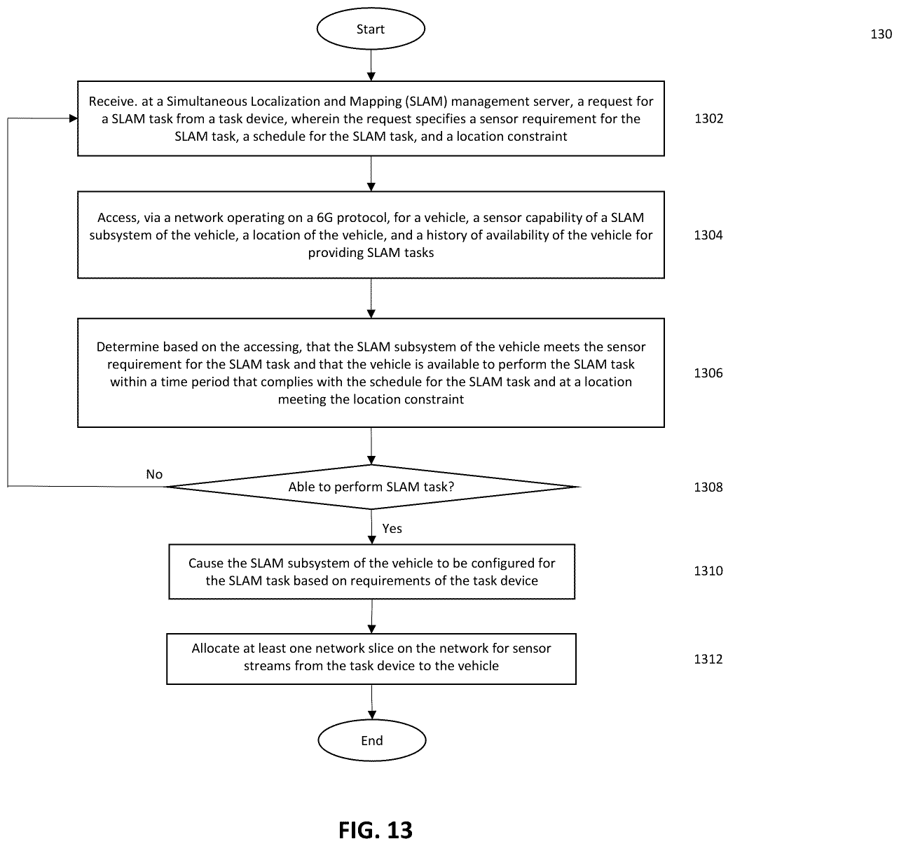

FIG. 13 is a flowchart of a detailed illustrative process for determining whether a SLAM subsystem of the vehicle meets the sensor requirement for the SLAM task and that the vehicle is available to perform the SLAM task, in accordance with some embodiments of this disclosure. In various embodiments, the individual steps of process 1300 may be implemented by one or more components of the devices and systems of FIGS. 1-12. Although the present disclosure may describe certain steps of process 1300 (and of other processes described herein) as being implemented by certain components of the devices and systems of FIGS. 1-12, this is for purposes of illustration only, and it should be understood that other components of the devices and systems of FIGS. 1-12 may implement those steps instead.

At 1302, the cloud service management server, via the control circuitry 1211, receives, at a SLAM management server, a request for a SLAM task from a task device. The request specifies a sensor requirement for the SLAM task, a schedule for the SLAM task, and a location constraint. As stated earlier, control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, the cloud service management server may receive the request via the communication network 1209 (e.g., which may be a configured on a 6G protocol), via the I/O path 1212 from user equipment 1107, 1108, 1110.

At 1304, the cloud service management server, via the control circuitry 1211, accesses via a network operating on a 6G protocol, for a vehicle, a sensor capability of a SLAM subsystem of the vehicle, a location of the vehicle, and a history of availability of the vehicle for providing SLAM tasks. In some embodiments, the cloud service management server may perform the accessing via the communication network 1209 (e.g., which may be a configured on a 6G protocol), via the I/O path 1212 from user equipment 1107, 1108, 1110. In some embodiments, the accessing may be from, server 1204, database 1205, or storage 1214.

At 1306, the cloud service management server, via the control circuitry 1211, determines based on the accessing, that the SLAM subsystem of the vehicle meets the sensor requirement for the SLAM task and that the vehicle is available to perform the SLAM task within a time period that complies with the schedule for the SLAM task and at a location meeting the location constraint. If, at 1308, the cloud service management server, via control circuitry 1211, determines the SLAM subsystem of the vehicle does not meet the sensor requirement for the SLAM task, the process reverts to 1302. If, at 1308, the cloud service management server, via control circuitry 1211, determines the SLAM subsystem of the vehicle meets the sensor requirement for the SLAM task, the process continues to 1310.

At 1310, the cloud service management server, via the control circuitry 1211, causes the SLAM subsystem of the vehicle to be configured for the SLAM task based on requirements of the task device. In some embodiments, the causing may be performed via the communication network 1209 (e.g., which may be configured on a 6G protocol), and/or via the I/O path 1212.

At 1312, the cloud service management server, via the control circuitry 1211, allocates at least one network slice on the network for sensor streams from the task device to the vehicle. In some embodiments, the allocation may be performed via the communication network 1209 (e.g., which may be configured on a 6G protocol), and/or via the I/O path 1212.

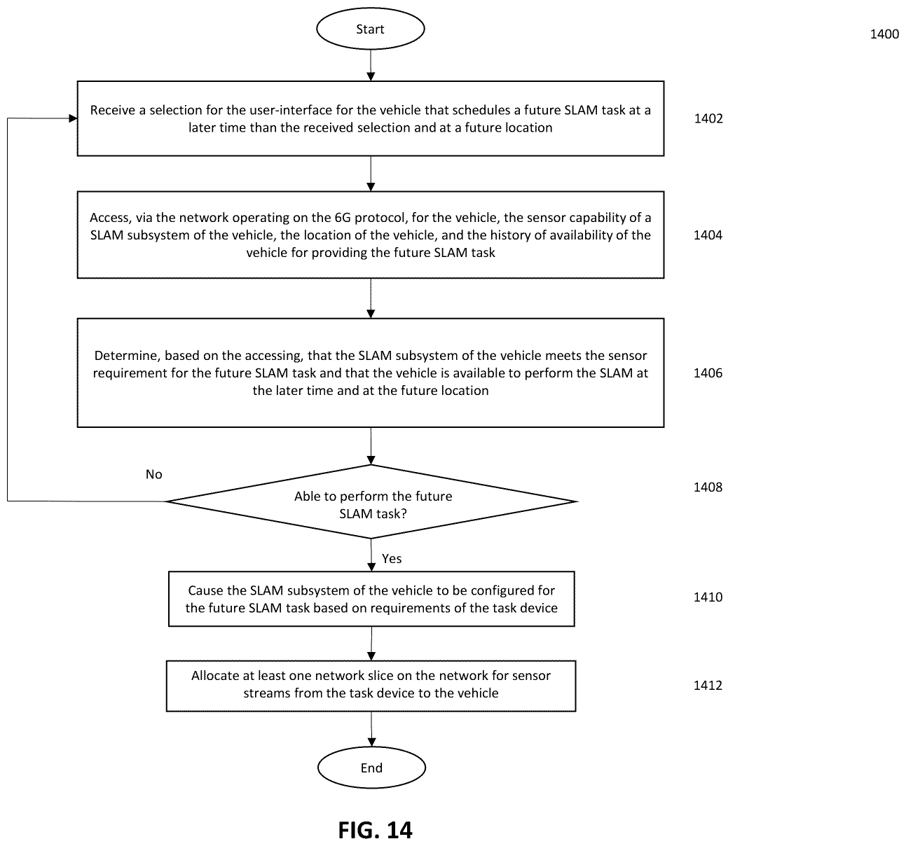

FIG. 14 is a flowchart of a detailed illustrative process 1400 for scheduling a future SLAM task, in accordance with some embodiments of this disclosure. At 1402, the cloud service management server, via the control circuitry 1211, receives a selection for the user-interface for the vehicle that schedules a future SLAM task at a later time than the received selection and at a future location. In some embodiments, the cloud service management server may receive the request via the communication network 1209 (e.g., which may be a configured on a 6G protocol), via the I/O path 1212 from user equipment 1107, 1108, 1110.

At 1404, the cloud service management server, via the control circuitry 1211, accesses via the network operating on the 6G protocol, for the vehicle, the sensor capability of a SLAM subsystem of the vehicle, the location of the vehicle, and the history of availability of the vehicle for providing the future SLAM task. In some embodiments, the cloud service management server may perform the accessing via the communication network 1209 (e.g., which may be a configured on a 6G protocol), via the I/O path 1212 from user equipment 1107, 1108, 1110. In some embodiments, the accessing may be from, server 1204, database 1205, or storage 1214.

At 1406, the cloud service management server, via the control circuitry 1211, determines based on the accessing, that the SLAM subsystem of the vehicle meets the sensor requirement for the future SLAM task and that the vehicle is available to perform the SLAM at the later time and at the future location. If, at 1408, the cloud service management server, via control circuitry 1211, determines the SLAM subsystem of the vehicle does not meet the sensor requirement for the future SLAM task, the process reverts to 1402. If, at 1408, the cloud service management server, via control circuitry 1211, determines the SLAM subsystem of the vehicle meets the sensor requirement for the future SLAM task, the process continues to 1410.

At 1410, the cloud service management server, via the control circuitry 1211, causes the SLAM subsystem of the vehicle to be configured for the future SLAM task based on requirements of the task device. In some embodiments, the causing may be performed via the communication network 1209 (e.g., which may be configured on a 6G protocol), and/or via the I/O path 1212.

At 1412, the cloud service management server, via the control circuitry 1211, allocates at least one network slice on the network for sensor streams from the task device to the vehicle. In some embodiments, the allocation may be performed via the communication network 1209 (e.g., which may be configured on a 6G protocol), and/or via the I/O path 1212.

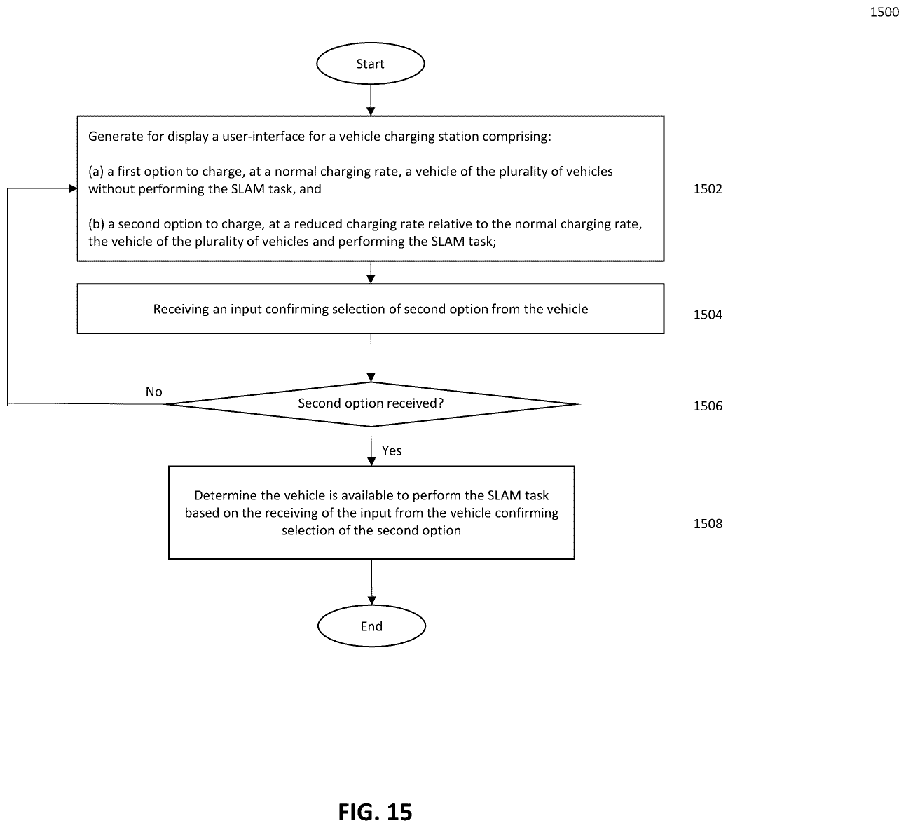

FIG. 15 is a flowchart of a detailed illustrative process 1500 for generating for display a user-interface for a vehicle charging station, in accordance with some embodiments of this disclosure. At 1502, the cloud service management server, via the control circuitry 1151, generates for display a user-interface for a vehicle charging station comprising (a) a first option to charge, at a normal charging rate, a vehicle of the plurality of vehicles without performing the SLAM task, and (b) a second option to charge, at a reduced charging rate relative to the normal charging rate, the vehicle of the plurality of vehicles and performing the SLAM task. In some embodiments, the cloud service management server generates the user-interface via the communication network 1209 (e.g., which may be configured on a 6G protocol), via the I/O path 1152 from user equipment 1107, 1108, 1110. In some embodiments, the cloud service management server may retrieve data used for the user-interface from, server 1204, database 1205, or storage 1154.

At 1504, the cloud service management server, via the control circuitry 1151, receives an input selection from the vehicle. In some embodiments, the cloud service management server receives the input confirming selection via the communication network 1209 (e.g., which may be configured on a 6G protocol), via the I/O path 1152 from user equipment 1107, 1108, 1110. If, at 1506, the cloud service management server, via control circuitry 1151, the input selection from the vehicle does not confirm selection of the second option, the process reverts to 1502. If, the input selection from the vehicle confirms selection of the second option, the process continues to 1508.

At 1508, the cloud service management server, via the control circuitry 1151, determines the computing set of the plurality of vehicles is available to perform the SLAM task based on the receiving of the input from the vehicle confirming selection of the second option.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving at a Simultaneous Localization and Mapping (SLAM) management server a request for a SLAM task from a task device, wherein the request specifies a sensor requirement for the SLAM task, a schedule for the SLAM task, and a location constraint;
accessing, via a network operating on a 6G protocol, for a vehicle, a sensor capability of a SLAM subsystem of the vehicle, a location of the vehicle, and a history of availability of the vehicle for providing SLAM tasks;
determining based on the accessing, that the SLAM subsystem of the vehicle meets the sensor requirement for the SLAM task and that the vehicle is available to perform the SLAM task within a time period that complies with the schedule for the SLAM task and at a location meeting the location constraint; and
in response to the determining:
causing the SLAM subsystem of the vehicle to be configured for the SLAM task based on requirements of the task device; and
allocating at least one network slice on the network for sensor streams from the task device to the vehicle:
wherein the task device is configured to stream sensor data from local sensors of the task device to the SLAM subsystem of the vehicle via the allocated at least one network slice; and
wherein the vehicle is configured to input the sensor data from local sensors of the task device into the SLAM subsystem of the vehicle to compute SLAM data for the task device.

2. The method of claim 1, wherein the vehicle is configured to stream the computed SLAM data computed by the SLAM subsystem of the vehicle to the task device via the allocated at least one network slice.

3. The method of claim 1, wherein the vehicle is configured to stream the computed SLAM data computed by the SLAM subsystem of the vehicle to the task device via a different allocated network slice than the allocated at least one network slice.

4. The method of claim 1, wherein the sensor requirement for the SLAM task may include at least of: optical camera, infrared camera, IMU, heat camera, accelerometer, LIDAR, RADAR, SONAR, or ultrasonic sensor.

5. The method of claim 1,
wherein the stream sensor data from local sensors of the task device to the SLAM subsystem of the vehicle comprises a plurality of sensor streams;
the method further comprising:
receiving a determination from the vehicle that a particular sensor stream of the plurality of sensor streams does not meet a quality-of-service threshold for the SLAM subsystem; and
causing the task device to transmit the particular sensor stream with higher quality.

6. The method of claim 1, further comprising:
generating for display a user-interface for a vehicle charging station comprising (a) a first option to charge, at a normal charging rate, the vehicle without performing the SLAM task, and (b) a second option to charge, at a reduced charging rate relative to the normal charging rate, the vehicle and performing the SLAM task;
receiving an input confirming selection of second option from the vehicle; and
wherein the determining whether the vehicle is available to perform the SLAM task comprises determining whether the vehicle is available to perform the SLAM task based on the receiving of the input from the vehicle confirming selection of the second option.

7. The method of claim 6, further comprising:
accessing a selection history for the vehicle, wherein the selection history comprises historical option selection from the user-interface for the vehicle at the vehicle charging station; and
wherein the determining whether the vehicle is available to perform the SLAM task comprises:
determining whether the selection history for the vehicle exceeds a second option threshold, wherein the second option threshold comprises a probability than the second option is more often selected than the first option.

8. The method of claim 6, further comprising:
receiving a selection for the user-interface for the vehicle that schedules a future SLAM task at a later time than the received selection and at a future location;
accessing, via the network operating on the 6G protocol, for the vehicle, the sensor capability of a SLAM subsystem of the vehicle, the location of the vehicle, and the history of availability of the vehicle for providing the future SLAM task;
determining, based on the accessing, that the SLAM subsystem of the vehicle meets the sensor requirement for the future SLAM task and that the vehicle is available to perform the SLAM at the later time and at the future location; and
in response to the determining that the SLAM subsystem of the vehicle meets the sensor requirement for the future SLAM task:
causing the SLAM subsystem of the vehicle to be configured for the future SLAM task based on requirements of the task device;
allocating at least one network slice on the network for the sensor streams from the task device to the vehicle:
wherein the task device is configured to stream sensor data from local sensors of the task device to the SLAM subsystem of the vehicle via the allocated at least one network slice; and
wherein the vehicle is configured to input the sensor data from local sensors of the task device into the SLAM subsystem of the vehicle to compute SLAM data for the task device.

9. The method of claim 1, further comprising:
determining whether the allocated at least one network slice on the network for sensor stream from the task device to the vehicle exceeds a bandwidth capacity threshold;
in response to the determining that the allocated at least one network slice on the network for the sensor stream from the task device to the vehicle exceeds the bandwidth capacity threshold, allocating a new network slice on the network for the sensor streams, wherein the new network slice has a higher bandwidth capacity than the allocated at least one network slice.

10. The method of claim 1, wherein the task device comprises at least one of: a robot dog, a robot appliance, a robotic device, a robotic drone, or a robot assistant.

11. The method of claim 1, wherein the determining based on the accessing comprises:
receiving a schedule threshold value that permits deviation of the time period by the threshold value, wherein the deviation of the time period is the deviated time period; and
in response to determining that the vehicle is not available to perform the SLAM task within the time period, determining that the vehicle is available to perform the SLAM task within the deviated time period.

12. A system comprising:
control circuitry configured to:
receive at a Simultaneous Localization and Mapping (SLAM) management server a request for a SLAM task from a task device, wherein the request specifies a sensor requirement for the SLAM task, a schedule for the SLAM task, and a location constraint;
access, via a network operating on a 6G protocol, for a vehicle, a sensor capability of a SLAM subsystem of the vehicle, a location of the vehicle, and a history of availability of the vehicle for providing SLAM tasks;
determine based on the accessing, that the SLAM subsystem of the vehicle meets the sensor requirement for the SLAM task and that the vehicle is available to perform the SLAM task within a time period that complies with the schedule for the SLAM task and at a location meeting the location constraint; and
in response to the determining:
cause the SLAM subsystem of the vehicle to be configured for the SLAM task based on requirements of the task device; and
allocate at least one network slice on the network for sensor streams from the task device to the vehicle:
wherein the task device is configured to stream sensor data from local sensors of the task device to the SLAM subsystem of the vehicle via the allocated at least one network slice; and
wherein the vehicle is configured to input the sensor data from local sensors of the task device into the SLAM subsystem of the vehicle to compute SLAM data for the task device.

13. The system of claim 12, wherein the vehicle is configured to stream the computed SLAM data computed by the SLAM subsystem of the vehicle to the task device via the allocated at least one network slice.

14. The system of claim 12, wherein the vehicle is configured to stream the computed SLAM data computed by the SLAM subsystem of the vehicle to the task device via a different allocated network slice than the allocated at least one network slice.

15. The system of claim 12, wherein the sensor requirement for the SLAM task may include at least of: optical camera, infrared camera, IMU, heat camera, accelerometer, LIDAR, RADAR, SONAR, or ultrasonic sensor.

16. The system of claim 12,
wherein the stream sensor data from local sensors of the task device to the SLAM subsystem of the vehicle comprises a plurality of sensor streams;
and wherein the system is further configured to:
receive a determination from the vehicle that a particular sensor stream of the plurality of sensor streams does not meet a quality-of-service threshold for the SLAM subsystem; and
cause the task device to transmit the particular sensor stream with higher quality.

17. The system of claim 12, wherein the system is further configured to:
generate for display a user-interface for a vehicle charging station comprising (a) a first option to charge, at a normal charging rate, the vehicle without performing the SLAM task, and (b) a second option to charge, at a reduced charging rate relative to the normal charging rate, the vehicle and performing the SLAM task;
receive an input confirming selection of second option from the vehicle; and
wherein the determining whether the vehicle is available to perform the SLAM task comprises determining whether the vehicle is available to perform the SLAM task based on the receiving of the input from the vehicle confirming selection of the second option.

18. The system of claim 17, wherein the system is further configured to:
access a selection history for the vehicle, wherein the selection history comprises historical option selection from the user-interface for the vehicle at the vehicle charging station; and
wherein the determining whether the vehicle is available to perform the SLAM task comprises:
determine whether the selection history for the vehicle exceeds a second option threshold, wherein the second option threshold comprises a probability than the second option is more often selected than the first option.

19. The system of claim 17, wherein the system is further configured to:
receive a selection for the user-interface for the vehicle that schedules a future SLAM task at a later time than the received selection and at a future location;
access, via the network operating on the 6G protocol, for the vehicle, the sensor capability of a SLAM subsystem of the vehicle, the location of the vehicle, and the history of availability of the vehicle for providing the future SLAM task;
determine, based on the accessing, that the SLAM subsystem of the vehicle meets the sensor requirement for the future SLAM task and that the vehicle is available to perform the SLAM at the later time and at the future location; and
in response to the determining that the SLAM subsystem of the vehicle meets the sensor requirement for the future SLAM task:
cause the SLAM subsystem of the vehicle to be configured for the future SLAM task based on requirements of the task device;
allocate at least one network slice on the network for the sensor streams from the task device to the vehicle:
wherein the task device is configured to stream sensor data from local sensors of the task device to the SLAM subsystem of the vehicle via the allocated at least one network slice; and
wherein the vehicle is configured to input the sensor data from local sensors of the task device into the SLAM subsystem of the vehicle to compute SLAM data for the task device.

20. The system of claim 12, wherein the system is further configured to:
determine whether the allocated at least one network slice on the network for sensor stream from the task device to the vehicle exceeds a bandwidth capacity threshold;
in response to the determining that the allocated at least one network slice on the network for the sensor stream from the task device to the vehicle exceeds the bandwidth capacity threshold, allocate a new network slice on the network for the sensor streams, wherein the new network slice has a higher bandwidth capacity than the allocated at least one network slice.

21-55. (canceled)
